(19) United States
(12) Patent Application Publication
(10) Pub. No.: US 2017/0298230 A1
(43) Pub. Date: Oct. 19, 2017

(54) Pigmentable Primer

(71) Applicants: Uwe Schümann, Pinneberg (DE); Sebastian Dietze, Hamburg (DE); Tim Baumann, Hamburg (DE); Patrick Boecker, Sparta, MI (US)

(72) Inventors: Uwe Schümann, Pinneberg (DE); Sebastian Dietze, Hamburg (DE); Tim Baumann, Hamburg (DE); Patrick Boecker, Sparta, MI (US)

(73) Assignee: tesa SE, Norderstedt (DE)

(21) Appl. No.: 15/157,845

(22) Filed: May 18, 2016

Related U.S. Application Data
(60) Provisional application No. 62/321,934, filed on Apr. 13, 2016.

(51) Int. Cl. C09D 5/00; C08F 220/18; C09D 133/08; C09D 7/12; C08K 5/5455; C08K 5/5425

(52) U.S. Cl. CPC C09D 5/002; C09D 133/08; C09D 7/1233; C08F 220/18; C08K 5/5425; C08K 5/5455

(57) ABSTRACT

The invention relates to a primer for improving the adhesion of adhesive tapes to hydrophilic surfaces, such as, in particular, glass or ceramic. The primer according to the invention comprises, dissolved or dispersed in one or more solvents, a mixture G of
at least one copolymer obtained by copolymerization of a monomer mixture comprising to at least 90 wt. % the following monomers:
vinylcaprolactam and/or vinylpyrrolidone and one or more of the monomers a) and b):
   c) acrylic acid ester of a linear, primary alcohol having 2 to 10 carbon atoms in the alkyl radical of the alcohol,
   d) acrylic acid ester of a branched, non-cyclic alcohol having 3 to 12 carbon atoms in the alkyl radical of the alcohol,
at least one organofunctional silane of the general structure (Ia) or (Ib)

(R¹O—)ₓSi(CH₂OR²)_{y}(R³)_{z} (Ia)

(R¹O—)ₓSi(CH₂NHR²)_{y}(R³)_{z} (Ib), wherein
the radicals R¹ independently of each other represent a C₁-C₄-alkyl radical, a C₂-C₆-alkoxyalkyl radical or an acetyl radical;
the radicals R² independently of each other represent an organic radical;
the radicals R³ independently of each other represent a C₁-C₁₈-alkyl radical and
x=1, 2 or 3; y=1, 2 or 3; x+y≦4 and z=4−x−y;
at least one metal compound selected from the group consisting of metal acetylacetonates, metal alkoxides and alkoxy-metal acetylacetonates,
at least one amine.

The present invention relates to the technical field of primers for improving the adhesion of adhesive tapes, in particular to hydrophilic surfaces, such as, for example, surfaces of glass or ceramic. In particular, a primer composition which is used for improving the adhesion of polyacrylate-based adhesive tapes and can comprise pigments or other 15 functional, filler-like substances in a high concentration without the adhesion-promoting action being substantially impaired as a result is proposed. The primer composition proposed has a high initial strength and renders possible within a certain period of time the repositioning of an adhesive tape stuck on to this.

### PRIOR ART

Primers, often also called adhesion promoters, are known in many instances in the form of commercial products or from the technical literature. An overview of the substances and substance classes which can be used in primer formulations is to be found in J. Bielemann, Lackadditive (1998), chap. 4.3., pp. 114-129.

Primer compositions are disclosed in a large number of patent specifications, but primers with which an improvement in the adhesion of adhesive tapes is said to be achieved are described in only a few specifications.

The publication WO 2008/094721 A1 proposes in connection with adhesive tape uses a primer composition based on a maleic anhydride-modified polyolefin and an organic diamine, with which a improvement in adhesion to polyolefin-based materials is said to be achieved.

JP 2008-156566 A discloses for adhesive tape uses a primer composition based on an acidic acrylate polymer and a fluorine-containing copolymer.

For improving the adhesion of an adhesive tape to substrates treated with melamine resin, WO 02/100961 A1 proposes a primer composition which comprises an acrylate copolymer grafted with an aminoalkyl group which contains terminal primary amino groups, and furthermore an acrylate copolymer having carboxyl groups in the molecular chain and a solvent.

WO 03/052021 A1 describes a primer composition which comprises a polydiorganosiloxane/polyurea copolymer having electron-rich groups and can have the form of a primer, an adhesive, a pressure-sensitive adhesive or another coating material. This primer composition is also mentioned in connection with adhesive tape uses.

The publications EP 833 865 B1, EP 833 866 B1, EP 739 383 B1 and U.S. Pat. No. 5,602,202 describe primer compositions based on mixtures of styrene/diene block copolymers or styrene/hydrogenated diene block copolymers and selected polyacrylates, which are said to improve the adhesion of double-sided, pressure-sensitive, foamed adhesive tapes to both low-energy and higher-energy surfaces.

A primer which is suitable for improving the adhesion of adhesive tapes to substrates which are difficult to bond, in particular to galvanized steel and to thermoplastic elastomer based on olefins, such as e.g. PP/EPDM, is disclosed in DE 10 2011 077 510 A1.

However, none of the publications mentioned is concerned with adhesion promotion on glass.

Silane primers or silane adhesion promoters are often employed for adhesion promotion on hydrophilic substrates, such as e.g. glass. Such primers are described, for example, in DE 10 2009 007 930 A1 or DE 10 2007 030 196 A1, furthermore in EP 577 014 A1, EP 1 693 350 A1, EP 1 730 247 A1, US 2008 0245 271 A, U.S. Pat. No. 2,008,023 425 A or WO 2008/025846 A2.

However, the systems disclosed in the publications mentioned are not designed for improving the adhesion of adhesive tapes to glass. They accordingly comprise no components suitable for improving the adhesion to a pressure-sensitive adhesive, in particular the adhesion to a pressure-sensitive adhesive based on a copolymer of acrylic acid esters and optionally acrylic acid.

There is additionally a need for improvement if the incorporation of pigments or other functional fillers into the primer in a high concentration is desired. The very thinly liquid dispersions, solutions or preparations of the publications mentioned are often scarcely capable of accommodating such fillers.

U.S. Pat. No. 6,646,048 B2 discloses a primer composition of a reactive acrylic resin, which comprises two different methacrylates, a silane compound, an epoxy resin of the bisphenol A type and carbon black. This primer composition of a reactive acrylic resin and a silane is indeed suitable for improving the adhesion of a urethane-based sealing composition or of a reactive adhesive to glass, but it is to be regarded as unsuitable for improving the adhesion of a pressure-sensitive adhesive tape to glass. In contrast to a urethane-based sealing composition and a reactive adhesive, which still crosslink even after application and in this way can form a chemical compound with the primer, the polymer base of the pressure-sensitive adhesives is no longer reactive during application of the adhesive tape. An improvement in the adhesion between an adhesive tape and a glass substrate is therefore not achieved by the primer composition of U.S. Pat. No. 6,646,048 B2.

The publications DE 10 2013 206 369 A1 and DE 10 2013 206 376 A1 disclose primer compositions which render possible the incorporation of pigments and are designed for improving the adhesion of adhesive tapes to glass. A disadvantage here is that the initial strength of the primer compositions proposed is low, so that the repositioning of an adhesive tape stuck to a freshly applied primer is not possible. In an attempt to remove the adhesive tape again and to stick it again on a somewhat different place, the primer is either also peeled off from the substrate or it splits cohesively.

The object of the invention is generally to provide a primer for improving the adhesion of adhesive tapes to hydrophilic surfaces, such as, in particular, glass or ceramic. The primer should be configured such that it can have a filler content of pigments, in particular coloured pigments, but also of other functional fillers in a high concentration without the adhesion-promoting action of the primer being significantly reduced as a result. It should be possible to incorporate pigments into the primer in such a high concentration that on application of a thin layer of this primer to glass opacity is achieved. The term “thin layer” here means a layer thickness of the order of between approximately 5 μm and 20 μm. Opaque means that it should not be possible to see through the primer layer, that is to say that visible light thus should not shine through the primer layer.

The primer, in particular the primer having a filler content of pigments or fillers, should furthermore have a high initial strength. A high initial strength is regarded as being present if it is possible to stick a highly adhering adhesive tape to the primer layer immediately after evaporation of the solvent and to remove it again a maximum of a some minutes thereafter, optionally with destruction of the adhesive tape, without thereby destroying the primer layer or detaching this from the substrate.

The primer, in particular the primer having a filler content of pigments or fillers, should furthermore render possible the repositioning of a double-sided acrylate foam adhesive tape which is stuck on to this and has an adhesive strength of greater than 20 N/cm on steel. It should be possible in this context to remove the adhesive tape again without destruction immediately after being stuck on and to stick it on again at a somewhat different place, without the primer also being peeled off from the substrate or splitting cohesively.

Furthermore, advantageously 48 hours at the latest after sticking on it should no longer be possible to detach without destruction a double-sided acrylate foam adhesive tape having an adhesive strength of greater than 20 N/cm on steel from the primer layer applied to a surface of glass or ceramic. As far as possible splitting of the foam within the adhesive tape should occur, or at least a mixed fracture pattern with partial splitting of the foam.

Advantageously, the primer, in particular the primer having a filler content of pigments or fillers, should have a short flash-off time. Flash-off time is understood as meaning the time which elapses after application of the primer to the substrate, in particular to glass, until the solvent evaporates, that is to say the primer is “dry”.

Furthermore, the primer should be free from halogen-containing, in particular chlorine-containing substances.

In a first and general embodiment the invention relates to a primer which comprises, dissolved or dispersed in one or more solvents, a mixture G of
at least one copolymer obtained by copolymerization of a monomer mixture comprising to at least 90 wt. % the following monomers:
vinylcaprolactam and/or vinylpyrrolidone and one or more of the monomers a) and b):
   a) acrylic acid ester of a linear, primary alcohol having 2 to 10 carbon atoms in the alkyl radical of the alcohol,
   b) acrylic acid ester of a branched, non-cyclic alcohol having 3 to 12 carbon atoms in the alkyl radical of the alcohol,
at least one organofunctional silane of the general structure (Ia) or (Ib)

(R¹O—)ₓSi(CH₂OR²)_{y}(R³)_{z} (Ia)

(R¹O—)ₓSi(CH₂NHR²)_{y}(R³)_{z} (Ib), wherein
the radicals R¹ independently of each other represent a C₁-C₄-alkyl radical, a C₂-C₆-alkoxyalkyl radical or an acetyl radical;
the radicals R² independently of each other represent an organic radical;
the radicals R³ independently of each other represent a C₁-C₁₈-alkyl radical and
x=1, 2 or 3; y=1, 2 or 3; x+y≦4 and z=4−x−y;
at least one metal compound selected from the group consisting of metal acetylacetonates, metal alkoxides and alkoxy-metal acetylacetonates,
at least one amine.

“Vinylcaprolactam” means N-vinylcaprolactam (CAS no. 2235-00-9) and “vinylpyrrolidone” means N-vinyl-2-pyrrolidone (CAS no. 88-12-0).

The organofunctional silane is a so-called alpha-silane. This is understood as meaning silanes having a methylene bridge instead of the generally customary propylene bridge between the Si atom and the functional group OR² or NHR².

According to the invention a metal acetylacetonate is understood as meaning a coordination compound of acetylacetonate anions and metal cations. The general formula is: M(acac)ₘ. M here represents a metal cation, acac represents the acetylacetonate anion. The IUPAC name for acetylacetone is: pentane-2,4-dione, the CAS no. is: 123-54-6. m represents the number of acetylacetonate anions which are required for charge compensation. m depends on the oxidation number of the metal cation.

The term metal alkoxide is synonymous for “metal alcoholate”. These are coordination compounds of the general formula: M(OR)ₙ. M here represents a metal cation, OR represents an alcoholate anion. R represents an alkyl radical. n represents the number of alcoholate anions which are required for charge compensation. n depends on the oxidation number of the metal cation.

Alkoxy-metal acetylacetonates in this specification are understood as meaning mixed coordination compounds of both acetylacetonate and alcoholate anions and metal cations. The general formula is: M(acac)ₘ(OR)ₙ. M here represents a metal cation, acac represents the acetylacetonate anion, OR represents an alcoholate anion. R represents an alkyl radical. m and n represent the number of acetylacetonate or, respectively, alcoholate anions which are required for charge compensation. m and n depend on the oxidation number of the metal cation.

The amine can be aliphatic or aromatic.

Primers according to the invention have a strong adhesion to hydrophilic substrates, such as in particular glass or ceramic, on the one hand and to adhesive tapes, in particular those with polar pressure-sensitive adhesives, for example with pressure-sensitive adhesives based on polyacrylic acid esters, on the other hand. Primers according to the invention are therefore excellent adhesion promoters for bonding of adhesive tapes on glass and ceramic. It has been found that a doubled-sided adhesive tape based on acrylate foam which is stuck on to the primer layer and has an adhesive strength of greater than 20 N/cm on steel can no longer be detached from the primer layer without destruction as a rule 48 hours at the latest after being stuck on, the primer layer having been applied to a surface of glass or ceramic.

It is moreover possible to provide the primer according to the invention with a filler content of pigments, in particular coloured pigments, such as, for example, carbon black, or other functional fillers without the adhesion-promoting action thereof being reduced to an extent relevant for the use as a result. The initial strength of the primer, which is given by the rapid build up of both cohesion and adhesion, in particular to glass or ceramic, is also scarcely impaired by the addition of pigments or other functional fillers. As has been found, this also applies if the pigments or other functional fillers are contained in the primer layer in such a high concentration that the primer layer is impermeable to light, that is to say opaque, at an application thickness of approx. 5-20 μm on glass. The necessary concentration of the pigments here, depending on the pigment, is between 20 and 200 wt. %, based on the total weight of the copolymers.

Primers according to the invention render possible the repositioning of highly adhesive, double-sided acrylate foam adhesive tapes stuck on to these which have an adhesive strength of greater than 20 N/cm on steel. This property is also scarcely impaired by incorporated pigments or other functional fullers.

According to the invention, in agreement with DIN EN ISO 4618 a primer is understood as meaning a coating substance for producing a primer coating. Generally, a primer or coating substance is applied to the surface of a substrate, thereafter film formation occurs by evaporation of the solvent and/or by another chemical or physical curing or film formation process, and a further, other substance, for example a lacquer, a paint, an adhesive or an adhesive tape, can subsequently be applied to the layer produced in this way. Prerequisites for an adhesion-promoting action of a primer are that on the one hand a good adhesion of the primer layer to the substrate, the surface of which is also called the base, is achieved, and on the other hand the further, other substance to be applied to the primer layer produced likewise adheres well to this. A primer has an optimum adhesion-promoting action if during an attempt to peel off the substance applied to the primer or the adhesive product applied to the primer cohesive failure occurs within the substance, the adhesive product or the adhesive tape, or if destruction of the substrate to which the primer has been applied beforehand thereby occurs. If the forces required for peeling off the substance, adhesive product or adhesive tape applied to a substrate with primer are higher than they are if no primer is used, an improvement in the adhesion or an improvement in the adhesive strength exists. The higher the difference in peel strengths, the higher the improvement in adhesion or the improvement in adhesive strength.

A solvent in the context of the invention is any known liquid which is suitable for dissolving or at least finely dispersing mixture G without undergoing an undesirable chemical reaction with the constituents of this mixture. Preferred solvents according to the invention are organic solvents, for example esters, ketones, aliphatic and aromatic hydrocarbons. Particularly preferred solvents are those having a boiling point of less than or equal to 100° C. Very particularly preferred solvents are those of which the boiling points are less than 80° C., in particular ethyl acetate (CAS no. 141-78-6) and acetone (CAS no. 67-64-1). Solvents which are likewise very preferred are low molecular weight alcohols, in particular ethanol (CAS no. 64-17-5) and isopropanol (CAS no. 67-63-0), although the latter has a boiling point of just above 80° C., namely 82.6° C.

Mixtures of the solvents according to the invention are included in the inventive idea. A particularly preferred solvent mixture comprises ethyl acetate, acetone and one or more low molecular weight alcohols, in particular isopropanol.

Water and other inorganic solvents are likewise included in the inventive idea.

A dispersed mixture is understood as meaning a finely dispersed mixture. The degree of fine dispersion and homogeneity of the mixture is not strictly defined, but it must be sufficient for the formation of a closed layer to occur after the coating operation and for the size of the agglomerates and/or aggregates which are not dissolved at the molecular level to be sufficiently small that the function of the primer layer as an adhesion-promoting layer is ensured.

The mixture G contained in the primer according to the invention preferably comprises at least one copolymer which is obtained by free radical copolymerization of the following monomers:

vinylcaprolactam and/or vinylpyrrolidone and one or more of the following monomers a) and b):
a) acrylic acid ester of a linear, primary alcohol having 2 to 10 carbon atoms in the alkyl radical of the alcohol,
b) acrylic acid ester of a branched, non-cyclic alcohol having 3 to 12 carbon atoms in the alkyl radical of the alcohol,
   wherein the sum of vinylcaprolactam and vinylpyrrolidone and the monomers a) and b) preferably—in the event of several copolymers in each case—makes up 100 wt. % of the copolymer.

Preferably, the at least one copolymer of mixture G of the primer according to the invention is a pressure-sensitive adhesive. Particularly preferably, all the copolymers contained in mixture G are pressure-sensitive adhesives.

According to the invention, as is customary in general language, a pressure-sensitive adhesive is understood as meaning a substance which—in particular at room temperature—is permanently tacky and capable of sticking. It is characteristic of a pressure-sensitive adhesive that it can be applied to a substrate by pressure and remains stuck there, the pressure to be applied and duration of action of this pressure not being defined in more detail. In some cases, depending on the precise nature of the pressure-sensitive adhesive, the temperature and the atmospheric humidity as well as the substrate, the action of a brief, minimal pressure which does not go beyond a gentle touching for a short moment is sufficient to achieve the adhesion effect, and in other cases a longer duration of action of a high pressure may also be necessary.

Pressure-sensitive adhesives have particular characteristic viscoelastic properties which lead to the permanent tackiness and adhesiveness. It is characteristic of them that when they are deformed mechanically both viscous flow processes and the build up of elastic restoring forces occur. Both processes have a certain relationship to one another with respect to their particular content, depending both on the precise composition, the structure and the degree of crosslinking of the pressure-sensitive adhesive and on the speed and duration of the deformation and on the temperature.

The viscous flow proportion is necessary to achieve adhesion. Only the viscous contents, caused by macromolecules of relatively high mobility, render possible a good wetting and a good flowing on to the substrate to be bonded. A high content of viscous flow leads to a high pressure-sensitive tackiness (also called tack or surface tackiness) and therefore often also to a high adhesive strength. Highly crosslinked systems, crystalline or vitreously solidified polymers as a rule have no or at least only little pressure-sensitive tackiness because of a lack of flowable contents.

The elastic restoring forces proportion is necessary to achieve cohesion. It is caused, for example, by very long-chain and highly entangled as well as by physically or chemically crosslinked macromolecules and renders possible the transfer of the forces acting on an adhesive bond. They lead to an adhesive bond being able to withstand to a sufficient extent over a relatively long period of time a permanent load acting on it, for example in the form of a permanent shear stress.

For a more detailed description and quantification of the extent of the elastic and viscous content and the relationship of the contents to one another the parameters of storage modulus (G′) and loss modulus (G″), which can be determined by means of dynamic mechanical analysis (DMA), can be used. G′ is a measure of the elastic content, G″ a measure of the viscous content of a substance. Both parameters depend on the deformation frequency and the temperature.

The parameters can be determined with the aid of a rheometer. In this context the material to be investigated is exposed, for example, to a sinusoidally oscillating shear stress in a plate-plate arrangement. In apparatuses of controlled shear stress, the deformation is measured as a function of time and the shift of this deformation with respect to time compared with the introduction of the shear stress. This shift with respect to time is called the phase angle δ.

The storage modulus G′ is defined as follows: G′=(τ/γ)·cos(δ) (τ=shear stress, γ=deformation, δ=phase angle=phase shift between the shear stress and deformation vector). The definition of the loss modulus G″ is: G′=(τ/γ)·sin(δ) (τ=shear stress, γ=deformation, δ=phase angle=phase shift between the shear stress and deformation vector).

A substance in general has pressure-sensitive tackiness and is defined as having pressure-sensitive tackiness in the context of the invention if at room temperature, defined here as 23° C., in the deformation frequency range of from 10⁰ to 10¹ rad/sec G′ is at least partly in the range of from 10³ to 10⁷ Pa and if G″ likewise is at least partly in this range. “Partly” means that at least a section of the G′ curve lies within the window spanned by the deformation frequency range of from 10⁰ to 10¹ rad/sec inclusive (abscissa) and the range of the G′ values of from 10³ to 10⁷ Pa inclusive (ordinate), and if at least a section of the G″ curve likewise correspondingly lies within this window.

Pressure-sensitive adhesives which comprise vinylcaprolactam and/or vinylpyrrolidone in the copolymer conventionally have only average adhesive properties. It was all the more surprising that in the context of the present invention it was found that a primer which comprises as a pressure-sensitive adhesive a copolymer according to the invention having vinylcaprolactam and/or vinylpyrrolidone as monomer components has outstanding adhesion-promoting properties and establishes a very firm bonding of adhesive tapes to hydrophilic substrates, in particular glass.

Particularly preferably, the copolymer is a pressure-sensitive adhesive and the monomer mixture of the copolymer comprises only vinylcaprolactam and/or vinylpyrrolidone and one or more of the monomers a) and b), i.e. the copolymer is built up only from these monomers without comprising further copolymerizable monomers. A primer which is based on such a copolymer has particularly good adhesion-promoting properties. Moreover, the presence of other—in particular plasticizing—comonomers and components than those mentioned can be dispensed with. Thus, for example, comonomers having cyclic hydrocarbon units can be dispensed with completely.

Linear acrylic acid esters having 2 to 10 C atoms in the alkyl radical are ethyl acrylate, n-propyl acrylate, n-butyl acrylate, n-pentyl acrylate, n-hexyl acrylate, n-heptyl acrylate, n-octyl acrylate, n-nonyl acrylate, n-decyl acrylate. Preferably, the monomer mixture comprises n-butyl acrylate.

Branched non-cyclic acrylic acid esters having 3 to up to an including 12 carbon atoms in the alkyl radical of the alcohol are preferably selected from the group consisting of 2-ethylhexyl acrylate (EHA), 2-propylheptyl acrylate, isooctyl acrylate, isobutyl acrylate, isoamyl acrylate and isodecyl acrylate. The monomers b) are particularly preferably selected from the group consisting of 2-ethylhexyl acrylate (EHA), 2-propylheptyl acrylate and isooctyl acrylate. “Isooctyl acrylate” means acrylate acid esters in which the alcohol component is to be attributed to a mixture of primary isooctanols, that is to say to those alcohols which can be obtained from an isoheptene mixture by hydroformylation and subsequent hydrogenation.

The weight ratio of (monomers a) and b)):(vinylcaprolactam+vinylpyrrolidone) is preferably from 95:5 to 40:60, more preferably from 85:15 to 50:50, in particular from 80:20 to 60:40, for example from 75:25 to 65:35.

Very preferably, the monomer mixture comprises vinylcaprolactam and/or vinylpyrrolidone and exactly one monomer of the type a), n-butyl acrylate particularly preferably being selected as the monomer a). Vinylcaprolactam is particularly preferred as a further monomer. In particular, the monomer mixture therefore comprises vinylcaprolactam and n-butyl acrylate. In such a monomer mixture the weight ratio of n-butyl acrylate vinylcaprolactam is preferably from 95:5 to 50:50, more preferably from 80:20 to 60:40.

According to the invention, the monomer mixture can comprise up to 10 wt. %, based on the total weight of the monomer mixture, of further copolymerizable monomers, in addition to the monomers included in any case in the subject matter of the invention. Such further copolymerizable monomers which can be used are, without particular limitation, all the monomers or monomer mixtures known to the person skilled in the art which contain C═C double bonds which can undergo free radical polymerization. By way of example, the further monomers can be selected from the group consisting of: methyl acrylate, methyl methacrylate, ethyl methacrylate, benzyl acrylate, benzyl methacrylate, phenyl acrylate, phenyl methacrylate, isobornyl acrylate, isobornyl methacrylate, t-butylphenyl acrylate, t-butylphenyl methacrylate, dodecyl methacrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenyl acrylate, 4-biphenyl methacrylate, 2-naphthyl acrylate, 2-naphthyl methacrylate, tetrahydrofurfuryl acrylate, maleic anhydride, hydroxyethyl acrylate, hydroxypropyl acrylate, hydroxyethyl methacrylate, hydroxypropyl methacrylate, 6-hydroxyhexyl methacrylate, allyl alcohol, glycidyl acrylate, glycidyl methacrylate, 2-butoxyethyl acrylate, 2-butoxyethyl methacrylate, 3-methoxyacrylic acid methyl ester, 3-methoxybutyl acrylate, phenoxyethyl acrylate, phenoxyethyl methacrylate, 2-phenoxyethyl methacrylate, butyl diglycol methacrylate, ethylene glycol acrylate, ethylene glycol monomethyl acrylate, methoxy-polyethylene glycol methacrylate 350, methoxy-polyethylene glycol methacrylate 500, propylene glycol monomethacrylate, butoxydiethylene glycol methacrylate, ethoxytriethylene glycol methacrylate, dimethylaminopropylacrylamide, dimethylaminopropylmethacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide, furthermore N,N-dialkyl-substituted amides, such as, for example, N,N-dimethylacrylamide, N,N-dimethylmethacrylamide, N-benzylacrylamides, N-isopropylacrylamide, N-tert-butylacrylamide, N-tert-octylacrylamide, N-methylolacrylamide, N-methylolmethacrylamide, acrylonitrile, methacrylonitrile, vinyl ethers, such as vinyl methyl ether, ethyl vinyl ether, vinyl isobutyl ether, vinyl esters, such as vinyl acetate, vinylpyridine, 4-vinylpyridine, N-vinylphthalimide, styrene, a- and p-methylstyrene, a-butylstyrene, 4-n-butylstyrene, 4-n-decylstyrene, 3,4-dimethoxystyrene. Macromonomers, such as 2-polystyrene-ethyl methacrylate (molecular weight MW of from 4,000 to 13,000 g/mol), poly(methyl methacrylate)ethyl methacrylate (MW of from 2,000 to 8,000 g/mol).

Preferably, the monomer mixture of the copolymer of the primer according to the invention comprises a maximum of 50 wt. %, particularly preferably a maximum of 40 wt. % of vinylcaprolactam and vinylpyrrolidone, based on the total weight of the monomer mixture. Likewise preferably, the monomer mixture preferably comprises at least 10 wt. %, particularly preferably at least 15 wt. %, in particular at least 20 wt. % of vinylcaprolactam and/or vinylpyrrolidone, based on the total weight of the monomer mixture. Very particularly preferably, the sum of the weight contents of vinylcaprolactam and vinylpyrrolidone in the monomer mixture is 10 to 50 wt. %, based on the total weight of the monomer mixture.

The monomer mixture preferably comprises a maximum of 1 wt. %, particularly preferably a maximum of 0.1 wt. %, based on the total weight of the monomer mixture, of acrylic acid. In particular, the monomer mixture is free from acrylic acid.

Preferably, the content of the copolymer or of the total amount of all the copolymers of mixture G, based on the total weight of the primer, is 1 to 30 wt. %, particularly preferably 2 to 20 wt. %, in particular 3 to 10 wt. %.

In the organofunctional silane of the general structure (Ia) or (Ib), the radicals R¹ independently of each other preferably represent a methyl, ethyl, 2-methoxyethyl or an acetyl radical, particularly preferably a methyl or ethyl radical. The radicals R³ independently of each other preferably represent a methyl, isooctyl, hexadecyl or a cyclohexyl radical. The radical R² preferably represents a cyclohexyl, methacryloyl or an alkoxycarbonyl radical. More preferably, the organofunctional silane is N-cyclohexylaminomethyltriethoxysilane (CAS no.: 26495-91-0), methacryloxymethylmethyldimethoxysilane (CAS no.: 121177-93-3), methacryloxymethyltrimethoxysilane (CAS no.: 54586-78-6), N-trimethoxysilylmethyl-O-methyl carbamate (CAS no. 23432-64-6) or N-dimethoxy(methyl)silylmethyl-O-methyl carbamate (CAS no.: 23432-65-7). Particularly preferably, the organofunctional silane is N-dimethoxy(methyl)silylmethyl-O-methyl carbamate (CAS no.: 23432-65-7).

Synonyms for “alkoxy-metal acetylacetonate” are metal alkoxide acetylacetonate or metal acetylacetonate alkoxide. According to the invention the metal compound may carry still further ligands without departing from the inventive idea.

The metal is preferably selected from the group consisting of titanium, aluminium, zirconium, zinc and iron; in particular, the metal is titanium or zirconium. Particularly preferably, the metal compound is selected from titanium or zirconium alkoxides. Very particularly preferably, the metal compound is titanium tetraisopropanolate Ti(iPr)₄.

The amine preferably contains no further functional groups, in particular no Si—O-alkyl group. It is thus preferably not simultaneously a silane. Preferably, the amine is a primary amine, in particular a diamine in which both amino group are primary.

The weight content of the total of all the metal compounds in mixture G is preferably greater than the weight content of the total of all the amines, particularly preferably at least 10 times greater.

A primer according to the invention can comprise further constituents beyond the substances mentioned so far, for example additives, such as other polymers, resins, plasticizers, stabilizers, rheological additives, fillers, pigments, crosslinking agents, initiators, catalysts, accelerators and the like.

Isocyanates can also advantageously be admixed in, although an immediate reaction with other ingredients of the primer can be expected. Particularly advantageously, tosyl isocyanate (CAS no. 4083-64-1) can be admixed to the primer according to the invention during its preparation. The content of the isocyanate is preferably 1 to 10 wt. %, particularly preferably 2 to 8 wt. %, based on the total weight of the primer.

Preferably, the primer according to the invention is free from polymers other than the copolymer(s) of mixture G, in particular free from chlorinated polyolefins.

Preferably, the primer according to the invention comprises no block copolymers of polystyrene/polydiene or polystyrene/hydrogenated polydiene type. In the context of this specification block copolymers of the polystyrene/polydiene or polystyrene/hydrogenated polydiene type are to understood as meaning all polymers of which the molecules consist of linked blocks of polystyrene and polydiene units or hydrogenated or partially hydrogenated polydiene units or comprise such blocks at least in considerable amounts. Typical examples of polydiene and hydrogenated or partially hydrogenated polydiene units are polybutadiene, polyisoprene, polymerized ethylene/butylene and ethylene/propylene blocks. It has been found, surprisingly, that block copolymers of the polystyrene/polydiene or polystyrene/hydrogenated polydiene type have the disadvantage as an additional constituent in the primer according to the invention of worsening the adhesion of the primer to hydrophilic surfaces, such as, in particular, glass or ceramic, compared with a primer according to the invention without this additional constituent. Furthermore, the addition of block copolymers of the polystyrene/polydiene or polystyrene/hydrogenated polydiene type to the primer according to the invention requires a different, less polar solvent or solvent mixture than would be necessary without this addition. In particular, the addition of toluene or naphtha is necessary in order to obtain a homogeneous primer solution. However, these solvents have a comparatively high boiling point, so that the desire for a short drying time (flash-off time) of the primer cannot be fulfilled with these.

Likewise preferably, the primer according to the invention is free from epoxy resins.

The primer according to the invention preferably comprises one or more fluorescent optical brighteners. This is advantageous because a primed base can be made identifiable in this manner. Without optical identification it is often difficult to distinguish a primed base from a non-primed base since the application thickness of a primer as a rule is very thin and therefore scarcely perceptible optically. A preferred fluorescent optical brightener is 2,5-thiophenediylbis(5-tert-butyl-1,3-benzoxazole), CAS no. 7128-64-5, commercially obtainable under the trade name Tinopal OB®.

Preferably, the sum of the weight contents of mixture G and the solvents in the primer according to the invention is at least 80%, more preferably at least 85%, in particular at least 90%, for example at least 92% and very particularly preferably at least 95%.

A primer according to the invention preferably comprises the following components in the amounts stated, in each case based on the total weight of the primer:

| | | |
|---|---|---|
| Copolymer(s) | 3 to 9 | wt. % |
| Solvent | 65 to 90 | wt. % |
| Silane(s) of the structure (Ia) or (Ib) | 0.5 to 7 | wt. % |
| Metal compound(s) | 5 to 17 | wt. % |
| Amine(s) | 0.1 to 2.0 | wt. % |
| Additives | 0 to 10 | wt. %, |

wherein the contents add up to 100 wt. %.

The invention also relates to the use of a primer according to the invention for producing an adhesion-promoting layer, preferably for producing an adhesion-promoting layer comprising pigments and/or other functional fillers, particularly preferably an adhesion-promoting layer comprising carbon black, in particular an adhesion-promoting layer pigmented opaquely black.

The invention also relates to a process for producing an adhesion-promoting layer on a substrate, which comprises applying a primer according to the invention to a substrate and removing the one or more solvents.

Primers according to the invention have an excellent adhesion to hydrophilic substrates, in particular glass, but also to many other hydrophilic surfaces, such as, for example, ceramic. Adhesive tapes with polar pressure-sensitive adhesives, in particular with pressure-sensitive adhesives based on copolymers of acrylic acid esters and acrylic acid, but also other adhesive tapes, adhere excellently to a primer according to the invention. The excellent adhesion manifests itself in that after a certain uptake time (as a rule 48 hours at the latest after sticking the adhesives tape on to the spread-on and dried primer) the adhesive tape is detachable predominantly only with destruction, that is to say with splitting of the pressure-sensitive adhesive of the adhesive tape or with detachment of the pressure-sensitive adhesive from the carrier of the adhesive tape or with splitting of the foam if the adhesive tape is one based on an acrylate foam. The term “uptake” is understood by the person skilled in the art as meaning in this context the increase in the bonding strength during storage of an adhesive bond of substrate, in this case primed substrate, and adhesive tape.

The initial strength (green strength) of the primers according to the invention is also surprisingly very high. The initial strength is understood as meaning the strength which the primer has a short time after evaporation of the solvent. “Short time” here means a maximum of 240 seconds. Strength here is understood as meaning the combined strength of both internal strength of the primer (cohesion) and adhesive strength (adhesion) to the substrate. Both adhesion and cohesion of the spread-on and dried primer are so high that immediately after evaporation of the solvent a highly adhering adhesive tape stuck on to the primer layer thus produced can be removed again, that is to say peeled off, if appropriate with destruction of the adhesive tape by splitting thereof, without thereby destroying the primer layer or detaching this from the solvent. A single-sided adhering woven adhesive tape having an adhesive strength of greater than 4 N/cm on steel can be regarded, for example, as highly adhering adhesive tape, or a double-sided adhesive tape based on acrylate foam which has an adhesive strength of greater than 20 N/cm on steel.

It has been found that primers according to the invention render possible the repositioning of a double-sided adhesive tape based on acrylate foam which is stuck on to the primer layer and has an adhesive strength of greater than 20 N/cm. The adhesive tape here can be removed again without destruction immediately after being stuck on and can be stuck on again at a somewhat different or also the same place without the primer also being peeled off from the substrate or split cohesively. The repositioning of an adhesive tape is necessary if it was not positioned correctly, was not in contact with the substrate surface over the complete area or another bonding error existed. The removal without destruction immediately after the adhesive tape has been stuck on is only possible, nevertheless, if the primer has cured sufficiently. This is the case as a rule after 240 seconds at the latest and depends on the precise primer composition and the age of the primer solution used. In contrast to the evaluation of the initial strength, the adhesive tape here is not stuck on to the primer layer immediately after evaporation of the solvent, but after this curing time of as a rule a maximum of 240 seconds from the point in time of complete evaporation of the solvent. Likewise in contrast to the evaluation of the initial strength, the adhesive tape here is immediately peeled off again as stated above.

In an advantageous embodiment primers according to the invention have a short flash-off time (drying time). This is as a rule a maximum of 60 seconds, usually a maximum of 40 seconds, if the solvents used are exclusively those having a boiling point of less than or equal to 100° C., preferably less than 80° C., and the layer thickness of the dried primer is between approximately 5 μm and 20 μm.

Particularly short flash-off times are achieved with solvent mixtures comprising ethyl acetate, acetone and isopropanol or ethanol.

Primers according to the invention could also be adjusted such that an adhesive tape, after several weeks of storage in damp heat or storage under changing climatic conditions (temperatures of from 60 to 90° C. under a simultaneous relative atmospheric humidity of greater than or equal to 80%) of the adhesive bond of the substrate coated with the primer and the adhesive tape stuck on to this, can be detached predominantly only with destruction of the adhesive tape.

In the context of the present invention it has been found, surprisingly, that the properties mentioned for the primers according to the invention are not reduced to an extent relevant to the use if coloured pigments, in particular carbon black, or other functional fillers, in particular mineral fillers, are admixed to the primers. This applies in particular to the adhesion on hydrophilic substrates, such as, for example, glass or ceramic, the adhesion of adhesive tapes on the spread-on and dried primer layers, the initial strength, the repositioning of an adhesive tape stuck on to the primer layer and the flash-off time.

Even if the primer layer comprises coloured pigments or other functional fillers in such a high concentration that the primer layer is impermeable to light, that is to say opaque, at an application thickness of approx. 5-20 μm on glass, the properties mentioned for the primers according to the invention are not reduced to an extent relevant to the use.

In this context, depending on the pigment, the necessary concentration of the pigments is between 20 and 200 wt. %, based on the total weight of the copolymers. The adhesive tapes also still adhere so well with this coloured pigment or filler concentration in the primer that after an uptake time of 24 hours at the latest cohesive failure within the adhesive tape occurs in the peel test on bondings on glass or ceramic.

It is possible to equip primers according to the invention with certain functionalities, namely if functional fillers are used. Thus not only can the primer be pigmented as described if coloured pigments, such as, for example, carbon black or titanium dioxide, are added, the primer can furthermore also be rendered electrically or thermally conductive if e.g. metal particles are added. The pH of the primer can also be adjusted by the choice of the filler, as a result of which, for example by using calcium oxide, an antibacterial action can be generated. Rheologically active fillers, such as, for example, pyrogenic silicas, can also be used, so that relatively thick, dimensionally stable primer layers can also be produced. It is furthermore possible to lower the costs for the primer by a high content of inexpensive mineral fillers, such as, for example, chalk, without the performance being measurably impaired.

This opens up a broad spectrum of new possible uses for primers. Properties which hitherto had to be realised by an adhesive, such as a pigmentation, can thus now be covered by the primer, which in turn brings the advantage that lower demands are to be made on the adhesive system.

An adhesion-promoting layer is produced with the primer according to the invention in a known manner, namely by first applying the primer to a substrate. Thereafter the solvent or solvents are allowed to evaporate, after which the adhesive tape can be applied. Only a few minutes, but also some days or weeks, can lie between application/evaporation of the solvent and the application of the adhesive tape.

### EXAMPLES SECTION

The following test methods were employed to characterize the samples produced according to the invention.

Dynamic Mechanical Analysis (DMA) for Determination of the Storage Modulus G′ and the Loss Modulus G″

To characterize the pressure-sensitive tackiness of the copolymers contained in the primer, determinations of the storage modulus G′ and the loss modulus G″ were carried out by means of dynamic mechanical analysis (DMA).

The measurements were carried out with the DSR 200 N rheometer of controlled shear stress from Rheometric Scientific in an oscillation test under a sinusoidally oscillating shear stress in a plate-plate arrangement. The storage modulus G′ and the loss modulus G″ were determined in the frequency sweep of from 10⁻¹ to 10² rad/sec at a temperature of 23° C. G′ and G″ are defined as follows:

G′=τ/γ·cos(δ) (τ=shear stress, γ=deformation, δ=phase angle=phase shift between the shear stress and deformation vector).

G″=τ/γ·sin(δ) (τ=shear stress, γ=deformation, δ=phase angle=phase shift between the shear stress and deformation vector).

The definition of the angular frequency is: ω=2π*f (f=frequency). The unit is rad/sec.

The thickness of the copolymer samples of pressure-sensitive tackiness measured was always between 0.9 and 1.1 mm (1+/−0.1 mm). The copolymer samples of pressure-sensitive tackiness were produced by spreading out the copolymers described below on to a double-sided siliconized polyester film (release liner), evaporating off the solvent at 70° C. and laying the 100 μm thick spread-out layers obtained in this way on top of one another until a thickness of approx. 1 mm was reached. The sample diameter was in each case 25 mm. Pretensioning was performed with a load of 3 N. The stress on the test specimens was 2,500 Pa for all the measurements.

Splitting of the Foam

The time until splitting of the foam occurs was determined by repeated measurements of the adhesive strength in accordance with PSTC-101 after specified times at room temperature using the acrylate foam test adhesive tapes 1-4 described below. In this method the primer was first applied thinly to the substrate (the base). This was carried out by brushing the primer on to the substrate. After the solvent had evaporated off a 7 to 25 mm wide strip of the adhesive tape was applied (stuck on) to the substrate which had now been provided with the primer in a layer thickness of from approximately 5 μm to 20 μm. The strip stuck on was then rolled over mechanically ten times by a 5 kg steel roller.

The time between the last rolling over of the adhesive tape and the peeling off was: a) 15 minutes, b) 30 minutes, c) 1 hour, d) 12 hours, e) 24 hours, f) 48 hours. The peel-off angle was in each case 90°, the peel-off rate was 300 mm/min. The time from when splitting of the foam occurs during peeling off was determined. The adhesive strength was always higher than 20 N/cm at this point in time. The adhesive strips measured were reinforced on the reverse with a 23 μm thick polyester film etched superficially with trichloroacetic acid. All the measurements were performed in a climatically controlled room at 23° C. and 50% relative atmospheric humidity. Glass plates and ceramic tiles served as the substrate.

Climate Storage

The composites of the substrates coated with the primer according to the invention and the acrylate foam test adhesive tapes 1 to 4, described below, stuck on to these were subjected to storage under selected climatic conditions in order to determine the climatic resistance of the bonding.

Storage a): storage for two weeks in a climate of 85° C. and 85% relative atmospheric humidity;

Storage b): storage for two weeks in an alternating climate with cycles of 4 hours at −40° C., 4 hours heating up/cooling, 4 hours at 80° C./80% relative atmospheric humidity.

After the storage time had elapsed the samples reinforced on the reverse with a 23 μm thick polyester film superficially etched with trichloroacetic acid were subjected to the adhesive strength test at a peel-off angle of in each case 90° and a peel-off rate of 300 mm/min in a climatically controlled room at 23° C. and 50% relative atmospheric humidity. The nature of the failure of the adhesive bond was determined. The adhesive strength in this context was always higher than 20 N/cm.

Transmission Measurement with a UV/VIS Spectrometer

The light transmission was measured with the UVIKON 923 UV/VIS spectrometer from Kontron in the wavelength range of from 190 to 850 nm.

Static Glass Transition Temperature

The static glass transition temperature is determined via dynamic differential scanning calorimetry in accordance with DIN 53765. The data on the glass transition temperature T_{g} relate to the glass transition temperature value T_{g} according to DIN 53765:1994-03, unless stated otherwise in the individual case. The heating up curves run with a heating rate of 10 K/min. The samples are measured in Al crucibles with a perforated lid under a nitrogen atmosphere. The second heating up curve is evaluated. A glass transition temperature is detectable as a point of inflection in the thermogram.

Molecular Weights

The determination of the average molecular weight Mw or of the average molecular weight M_{N} and of the polydispersity D was carried out by means of gel permeation chromatography (GPC). THF with 0.1 vol. % of trifluoroacetic acid was employed as the eluent. The measurement was performed at 25° C. PSS-SDV, 5 μm, 103 Å (10-7 m), ID 8.0 mm×50 mm was used as the precolumn. The columns PSS-SDV, 5 μm, 103 Å (10-7 m), 105 Å (10-5 m) and 106 Å (10-4 m) of in each case ID 8.0 mm×300 mm were employed for the separation. The sample concentration was 4 g/l, the flow rate was 1.0 ml per minute. Measurement was made against PMMA standards.

Solids Content

The solids content is a measure of the content of non-vaporizable constituents in a polymer solution. It is determined gravimetrically by weighing the solution, subsequently evaporating off the vaporizable contents for 2 hours at 120° C. in a drying cabinet and reweighing the residue.

K Value (According to FIKENTSCHER)

The K value is a measure of the average molecular size of highly polymeric substances. For the measurement, one percent strength (1 g/100 ml) solutions of the polymer in toluene were prepared and the kinematic viscosities thereof were determined with the aid of a VOGEL-OSSAG viscometer. After standardization to the viscosity of toluene, the relative viscosity is obtained, from which the K value can be calculated by the FIKENTSCHER method (Polymer 8/1967, 381 et seq.).

Flash-Off Time

The flash-off time is the time which elapses after application of the primer to the substrate until the solvent evaporates, that is to say the primer is “dry”. The measurement is carried out by applying the primer to a glass plate with a brush in a layer thickness of from 5 to 10 μm at 23° C. and then measuring the time until the solvent has evaporated. This point in time is determined optically. It can be recognized by the fact that the primer layer loses its gloss caused by the solvent.

Initial Strength

The initial strength is the strength which the primer has a short time after evaporation of the solvent. Strength is understood here as meaning the combined strength of both the internal strength of the primer (cohesion) and the adhesive strength (adhesion) to the substrate. The initial strength is determined by first applying the primer to glass analogously to the determination of the flash-off time. Immediately after evaporation of the solvent test adhesive tape 5 described below is stuck on to the primer layer produced in this way and briefly pressed on gently by hand. The adhesive tape is then peeled off again by hand after 15 seconds and in further analogous tests after 30 seconds, 60 seconds, 90 seconds and 120 seconds, 180 seconds and 240 seconds. The initial strength is reached at a sufficient level when on peeling off of the adhesive tape no primer residues are visible on the adhesive tape or the adhesive tape splits cohesively.

Repositionability

Repositionability exists if an adhesive tape stuck on to the dried primer layer can be removed again without destruction immediately after being stuck on, without the primer also being peeled off from the substrate or splitting cohesively.

Testing was carried out with the double-sided acrylate foam test adhesive tapes 1 to 4 described below, which each have an adhesive strength of greater than 20 N/cm on steel. The test is carried out by first applying the primer to glass analogously to the determination of the flash-off time. Immediately after evaporation of the solvent measurement of the time starts. After 15 seconds and in further analogous tests after 30 seconds, 45 seconds, 60 seconds, 90 seconds, 120 seconds, 180 seconds and 240 seconds the double-sided acrylate foam test adhesive tapes are stuck on to the primer layer produced in this way, briefly pressed on gently by hand and immediately peeled off again. Repositionability exists if on peeling off of the adhesive tape no primer residues are visible on the adhesive tape.

The following substrates (bases on which the primer was initially applied and on to which the adhesive tape was then stuck) were used:
a) Glass test specimen (Rocholl GmbH)
b) Ceramic tile (Baumarkt)

The test adhesive tapes which are not commercially obtainable (test adhesive tapes 1, 2 and 3) and with which the primer was tested were based on polyacrylate and polyacrylate/synthetic rubber pressure-sensitive adhesives. The following raw materials were used for the preparation of these pressure-sensitive adhesives:

| | | Manufacturer | |
|---|---|---|---|
| Chemical compound | Trade name | or supplier | CAS no. |
| Bis(4-tert- | Perkadox ®16 | Akzo Nobel | 15520-11-3 |
| butylcyclohexyl)peroxydicarbonate | | | |
| 2,2′-Azobis(2-methylpropionitrile), | Vazo ®64 | DuPont | 78-67-1 |
| AIBN | | | |
| 2,2′-Azobis(2-methylbutyronitrile) | Vazo ®67 | DuPont | 13472-08-7 |
| Pentaerythritol tetraglycidyl ether | Polypox ®R16 | UPPC AG | 3126-63-4 |
| 3,4-Epoxycyclohexylmethyl-3,4- | Uvacure ®1500 | Cytec | 2386-87-0 |
| epoxycyclohexanecarboxylate | | Industries Inc. | |
| Triethylenetetramine | Epikure ®925 | Hexion | 112-24-3 |
| | | Speciality | |
| | | Chemicals | |
| Microballoons (MB) | Expancel ®051 DU 40 | Expancel | |
| (dry-unexpanded microspheres, diameter 9 | | Nobel | |
| to 15 μm, expansion start temperature 106 | | Industries | |
| to 111° C., TMA density ≦25 kg/m³) | | | |
| Terpene phenolic resin (softening | Dertophene ®T110 | DRT resins | 25359-84-6 |
| point 110° C.; M_{w} = 500 to 800 g/mol; D = | | | |
| 1.50) | | | |
| Terpene phenolic resin (softening | Dertophene T105 | DRT resins | 25359-84-6 |
| point 105° C.; M_{w} = 500 to 800 g/mol) | | | |
| Acrylic acid n-butyl ester | n-Butyl acrylate | Rohm & Haas | 141-32-2 |
| Acrylic acid | Acrylic acid pure | BASF | 79-10-7 |
| 2-Ethylhexyl acrylate | | Brenntag | 103-11-7 |
| Methyl acrylate | | BASF | 96-33-3 |
| Styrene/butadiene block copolymer | Kraton D1118 | Kraton | 9003-55-8 |
| (approx. 31% polystyrene content) | | Polymers | |
| Polyoxyethylene(15)coco-amine | Ethomeen C/25 | Akzo Nobel | 61791-14-8 |
| Reofos RDP | Tetraphenylresorcinol | Chemtura | 57583-54-7 |
| | bis(diphenyl | | |
| | phosphate) | | |

The expansion capacity of the microballoons can be described by the determination of the TMA density [kg/m³] (Stare Thermal Analysis System from Mettler Toledo; heating rate 20° C./min). The TMA density here is the minimum density which can be achieved at a certain temperature Tₘₐₓ under normal pressure before the microballoons collapse.

The determination of the softening point of the resins is carried out in accordance with DIN ISO 4625.

The following solvents were furthermore used for the preparation of the polyacrylate pressure-sensitive adhesives contained in the test adhesive tapes which are not commercially obtainable:

| Name | CAS no. | Manufacturer |
|---|---|---|
| Special grade naphtha 60/95 | 64742-49-0 | Shell, Exxon |
| Acetone | 67-64-1 | Shell |
| Isopropanol | 67-63-0 | Shell |

Test Adhesive Tape 1

An example of polyacrylate pressure-sensitive adhesive 1 for producing test adhesive tape 1 was prepared as follows:

A conventional reactor for free radical polymerizations was filled with 54.4 kg of 2-ethylhexyl acrylate, 20.0 kg of methyl acrylate, 5.6 kg of acrylic acid and 53.3 kg of acetone/isopropanol (94:6). After passing nitrogen gas through for 45 minutes, while stirring, the reactor was heated up to 58° C. and 40 g of Vazo 67, dissolved in 400 g of acetone, were added. The external heating bath was then heated to 75° C. and the reaction was carried out under constant conditions at this external temperature. After 1 h 40 g of Vazo 67, dissolved in 400 g of acetone, were again added, and after 4 h the mixture was diluted with 10 kg of acetone/isopropanol mixture (94:6).

After 5 h and after 7 h in each case the reaction was after-initiated with 120 g of bis(4-tert-butylcyclohexyl)peroxydicarbonate, in each case dissolved in 400 g of acetone. After a reaction time of 22 h the polymerization was interrupted and the mixture was cooled to room temperature. The product had a solids content of 55.9% and was freed from the solvent in a concentrating extruder under reduced pressure (residual solvent content≦0.3 percent by weight). The resulting polyacrylate had a K value of 58.8, an average molecular weight of Mw=746,000 g/mol, a polydispersity of D (Mw/Mn)=8.9 and a static glass transition temperature of T_{g}=−35.6° C.

This base polymer was melted in a feeder extruder (single-screw conveying extruder from TROESTER GmbH & Co KG, Germany) and with this as the polymer melt was conveyed via a heatable hose into a planetary roller extruder from Entex (Bochum). The molten resin Dertophene T 110 was now added via a metering opening so that a concentration of the resin in the melt of 28.3 percent by weight resulted. The crosslinking agent Polypox R16 was furthermore added. Its concentration in the melt was 0.14 percent by weight. All the components were mixed to a homogeneous polymer melt.

The polymer melt was transferred into a twin screw extruder (Berstorff) by means of a melt pump and a heatable hose. The accelerator Epikure 925 was added there. Its concentration in the melt was 0.14 percent by weight. The entire polymer mixture was then freed from all gas inclusions in a vacuum dome under a pressure of 175 mbar. After the vacuum dome, the microballoons were metered in and incorporated homogeneously into the polymer mixture by means of a mixing element. Their concentration in the melt was 0.7 percent by weight. The melt mixture formed was transferred into a nozzle.

After leaving the nozzle, that is to say after a drop in pressure, the microballoons incorporated expanded, a shear-free cooling of the polymer mass taking place due to the drop in pressure. A foamed polyacrylate pressure-sensitive adhesive was formed, which was then shaped by means of a roll calender into the form of a web in a thickness of 0.8 mm and covered with a double-sided siliconized release film (50 μm polyester), during which the chemical crosslinking reaction progressed. The wound-up film was stored at room temperature for four weeks, before it was used further for the primer testing. The wound-up film is test adhesive tape 1.

Test Adhesive Tape 2

An example of polyacrylate pressure-sensitive adhesive 2A for producing the middle layer of the three-layered test adhesive tape 2 was prepared as follows:

A conventional reactor for free radical polymerizations was filled with 30.0 kg of 2-ethylhexyl acrylate, 67.0 kg of butyl acrylate, 3.0 kg of acrylic acid and 66.7 kg of acetone/isopropanol (96:4). After passing nitrogen gas through for 45 minutes, while stirring, the reactor was heated up to 58° C. and 50 g of Vazo 67, dissolved in 500 g of acetone, were added. The external heating bath was then heated to 70° C. and the reaction was carried out under constant conditions at this external temperature. After 1 h 50 g of Vazo 67, dissolved in 500 g of acetone, were again added, and after 2 h the mixtures was diluted with 10 kg of acetone/isopropanol mixture (96:4). After 5.5 h 150 g of bis(4-tert-butylcyclohexyl)peroxydicarbonate, dissolved in 500 g of acetone, were added; after 6 h 30 min the mixture was diluted again with 10 kg of acetone/isopropanol mixture (96:4). After 7 h a further 150 g of bis(4-tert-butylcyclohexyl)peroxydicarbonate, dissolved in 500 g of acetone, were added and the heating bath was regulated at a temperature of 60° C.

After a reaction time of 22 h the polymerization was interrupted and the mixture was cooled to room temperature. The product had a solids content of 50.2% and was dried.

The resulting polyacrylate had a K value of 75.2, an average molecular weight of Mw=1,370,000 g/mol, a polydispersity of D (Mw/Mn)=17.13 and a static glass transition temperature of Tg=−38.0° C.

This base polymer was melted in a feeder extruder (single-screw conveying extruder from TROESTER GmbH & Co KG, Germany) and with this as the polymer melt was conveyed via a heatable hose into a planetary roller extruder from Entex (Bochum). The crosslinking agent Polypox R16 was now added via a metering opening. Its concentration in the melt was 0.22 percent by weight. All the components were mixed to a homogeneous polymer melt.

The polymer melt was transferred into a twin screw extruder (Berstorff) by means of a melt pump and a heatable hose. The accelerator Epikure 925 was added there. Its concentration in the melt was 0.14 percent by weight. The entire polymer mixture was then freed from all gas inclusions in a vacuum dome under a pressure of 175 mbar. After the vacuum dome, the microballoons were metered in and incorporated homogeneously into the polymer mixture by means of a mixing element. Their concentration in the melt was 2.0 percent by weight. The melt mixture formed was transferred into a nozzle.

After leaving the nozzle, that is to say after a drop in pressure, the microballoons incorporated expanded, a shear-free cooling of the polymer mass taking place due to the drop in pressure. The foamed polyacrylate pressure-sensitive adhesive 2A was formed, which was then shaped by means of a roll calender into the form of a web in a thickness of 0.8 mm and covered with a double-sided siliconized release film (50 μm polyester), during which the chemical crosslinking reaction progressed. The wound-up film was stored for one day at room temperature before the further processing (see below).

An example of polyacrylate pressure-sensitive adhesive 2B for producing the two outer layers of the three-layered test adhesive tape 2 was prepared as follows:

A conventional 100 l glass reactor for free radical polymerizations was filled with 4.8 kg of acrylic acid, 11.6 kg of butyl acrylate, 23.6 kg of 2-ethylhexyl acrylate and 26.7 kg of acetone/special naphtha 60/95 (1:1). After passing nitrogen gas through for 45 minutes, while stirring, the reactor was heated up to 58° C. and 30 g of AIBN were added. The external heating bath was then heated to 75° C. and the reaction was carried out under constant conditions at this external temperature. After a reaction time of 1 h 30 g of AIBN were again added. After 4 and 8 h the mixture was diluted with in each case 10.0 kg of acetone/special naphtha 60/95 (1:1) mixture. For reduction of the residual initiators, after 8 h and 10 h in each case 90 g of bis(4-tert-butylcyclohexyl)peroxydicarbonate were added. The reaction was interrupted after a reaction time of 24 h and the mixture was cooled to room temperature. The polyacrylate was then blended with 0.2 percent by weight of the crosslinking agent Uvacure® 1500, the mixture was diluted with acetone to a solids content of 30% and then coated from solution on to a double-sided siliconized release film (50 μm polyester). (Coating speed 2.5 m/min, drying tunnel 15 m, temperature zone 1: 40° C., zone 2: 70° C., zone 3: 95° C., zone 4: 105° C.). The thickness was 50 μm. The wound-up film was stored at room temperature for two days, before it was used further for producing test adhesive tape 2.

A film of the polyacrylate pressure-sensitive adhesive 2B was laminated on to both sides of the foamed film of the polyacrylate pressure-sensitive adhesive 2A. Immediately before laminating the film of the polyacrylate pressure-sensitive adhesive 2B on to the foamed film of the polyacrylate pressure-sensitive adhesive 2A, the particular surface to be laminated of the film of the polyacrylate pressure-sensitive adhesive 2A was subjected to air corona pretreatment at a corona dose of 35 Wmin/m². Before the second lamination the double-sided siliconized release film of the foamed polyacrylate pressure-sensitive adhesive 2A was uncovered. After the second lamination one of the double-sided siliconized release films of the two foamed polyacrylate pressure-sensitive adhesives 2B was uncovered. The three-layered composite of polyacrylate pressure-sensitive adhesive 2B/polyacrylate pressure-sensitive adhesive 2A/polyacrylate pressure-sensitive adhesive 2B was wound up and stored at room temperature for four weeks, before it was used further for the primer testing. The wound-up composite is test adhesive tape 2.

The polyacrylate pressure-sensitive adhesives described by way of example in their composition and preparation method are described in detail in DE 10 2010 062 669. The disclosure content of this specification is explicitly tied in with the disclosure content of the present description.

Test Adhesive Tape 3 (Single-Layered Adhesive Tape Based on a Polyacrylate/Synthetic Rubber Mixture)

An example of polyacrylate/synthetic rubber pressure-sensitive adhesive 3 for producing test adhesive tape 3 was prepared as follows:

A conventional reactor for free radical polymerizations was filled with 72.0 kg of 2-ethylhexyl acrylate, 20.0 kg of methyl acrylate, 8.0 kg of acrylic acid and 66.6 kg of acetone/isopropanol (94:6). After passing nitrogen gas through for 45 minutes, while stirring, the reactor was heated up to 58° C. and 50 g of AIBN, dissolved in 500 g of acetone, were added. The external heating bath was then heated to 75° C. and the reaction was carried out under constant conditions at this external temperature. After 1 h 50 g of AIBN, dissolved in 500 g of acetone, were again added, and after 4 h the mixture was diluted with 10 kg of acetone/isopropanol mixture (94:6).

After 5 h and after 7 h in each case the reaction was after-initiated with 150 g of bis(4-tert-butylcyclohexyl)peroxydicarbonate, in each case dissolved in 500 g of acetone. After a reaction time of 22 h the polymerization was interrupted and the mixture was cooled to room temperature. The product had a solids content of 55.8% and was freed from the solvent in a concentrating extruder under reduced pressure (residual solvent content≦0.3 percent by weight). The resulting polyacrylate base polymer had a K value of 58.9, an average molecular weight of Mw=748,000 g/mol, a polydispersity of D (Mw/Mn)=8.9 and a static glass transition temperature of Tg=−35.2° C.

The mixture with the synthetic rubber was prepared as follows:

The synthetic rubber Kraton D1118 as granules was melted in a planetary roller extruder via a solids metering unit. The addition of a microballoon paste (50% Expancel 051DU40 in Ethomeen C25) followed. The polyacrylate base polymer, which was premelted in a single-screw extruder, was fed in via a side feeder and a terpene phenolic resin (Dertophene DT105) was metered in. Crosslinking agent (Polypox R16 15% in Reofos RDP) and accelerator (15% Epicure 925 in Reofos RDP) solution was added to the mixture. The melt was mixed thoroughly and coated between two release films (siliconized PET film) via a two-roll calender. A single-layered adhesive tape having a layer thickness of 1,200 μm and a density of 550 kg/m³ resulted. This adhesive tape is test adhesive tape 3. The composition was 48% polyacrylate, 25% Kraton D1118, 18% Dertophene DT105, 4% crosslinking agent/accelerator solution (crosslinking agent:accelerator=1:1), 5% microballoon paste (data in wt. %). The adhesive strength on steel after an uptake time of 3 days was approx. 37 N/cm.

Test Adhesive Tape 4: 3M™ Acrylic Foam Tape 5314

Description: 760 μm thick, double-sided acrylate foam adhesive tape; adhesive strength on steel after an uptake time of 3 days: 70.1 N/cm (until the initial resistance at the start of peeling off is overcome), 24.4 N/cm (in the further course of peeling off); the uncovered side was used for the tests.

Test Adhesive Tape 5: Tesa® 4657

Description: 290 μm thick, single-sided adhesive tape with an acrylate-coated woven carrier and an adhesive composition based on natural rubber; adhesive strength on steel: approx. 4.6 N/cm.

The following raw materials were used for the preparation of the copolymer contained according to the invention in the primer:

| Chemical compound | Trade name | Manufacturer | CAS no. |
|---|---|---|---|
| N-Vinylcaprolactam | | Sigma-Aldrich | 2235-00-9 |
| N-Vinyl-2-pyrrolidone | | Sigma-Aldrich | 88-12-0 |
| Acrylic acid n-butyl ester | n-Butyl acrylate | Rohm & Haas | 141-32-2 |
| 2-Ethylhexyl acrylate | | Brenntag | 103-11-7 |
| Bis(4-tert- | Perkadox ®16 | Akzo Nobel | 15520-11-3 |
| butylcyclohexyl)peroxydicarbonate | | | |
| 2,2′-Azobis(2-methylpropionitrile), | Vazo ®64 | DuPont | 78-67-1 |
| AIBN | | | |

The following solvents were furthermore used for the preparation of the copolymer contained according to the invention in the primer:

| Name | CAS no. | Manufacturer |
|---|---|---|
| Special grade naphtha 60/95 | 64742-49-0 | Shell, Exxon |
| Acetone | 67-64-1 | Shell |

The polyacrylate pressure-sensitive adhesives for use as a constituent in the primer according to the invention were prepared as follows:

Primer Pressure-Sensitive Adhesive 1

A conventional 100 l glass reactor for free radical polymerizations was filled with 12.0 kg of N-vinylcaprolactam, 28.0 kg of butyl acrylate and 26.7 kg of acetone/special naphtha 60/95 (1:1). After passing nitrogen gas through for 45 minutes, while stirring, the reactor was heated up to 58° C. and 30 g of AIBN were added. The external heating bath was then heated to 75° C. and the reaction was carried out under constant conditions at this external temperature. After a reaction time of 1 h 30 g of AIBN were again added. After 4 and 8 h the mixture was diluted with in each case 10.0 kg of acetone/special naphtha 60/95 (1:1) mixture. For reduction of the residual initiators, after 8 h and after 10 h in each case 90 g of bis(4-tert-butylcyclohexyl)peroxydicarbonate were added. The reaction was interrupted after a reaction time of 24 h and the mixture was cooled to room temperature. The polyacrylate was diluted with acetone to a solids content of 40.0 percent by weight. The solution obtained in this way is primer pressure-sensitive adhesive 1.

Primer Pressure-Sensitive Adhesive 2

A conventional 100 l glass reactor for free radical polymerizations was filled with 8.0 kg of N-vinylcaprolactam, 32.0 kg of 2-ethylhexyl acrylate and 26.7 kg of acetone/special naphtha 60/95 (1:1). After passing nitrogen gas through for 45 minutes, while stirring, the reactor was heated up to 58° C. and 30 g of AIBN were added. The external heating bath was then heated to 75° C. and the reaction was carried out under constant conditions at this external temperature. After a reaction time of 1 h 30 g of AIBN were again added. After 4 and 8 h the mixture was diluted with in each case 10.0 kg of acetone/special naphtha 60/95 (1:1) mixture. For reduction of the residual initiators, after 8 h and after 10 h in each case 90 g of bis(4-tert-butylcyclohexyl)peroxydicarbonate were added. The reaction was interrupted after a reaction time of 24 h and the mixture was cooled to room temperature. The polyacrylate was diluted with acetone to a solids content of 40.0 percent by weight. The solution obtained in this way is primer pressure-sensitive adhesive 2.

Primer Pressure-Sensitive Adhesive 3

A conventional 100 l glass reactor for free radical polymerizations was filled with 8.0 kg of N-vinyl-2-pyrrolidone, 32 kg of butyl acrylate and 26.7 kg of acetone/special naphtha 60/95 (1:1). After passing nitrogen gas through for 45 minutes, while stirring, the reactor was heated up to 58° C. and 30 g of AIBN were added. The external heating bath was then heated to 75° C. and the reaction was carried out under constant conditions at this external temperature. After a reaction time of 1 h 30 g of AIBN were again added. After 4 and 8 h the mixture was diluted with in each case 10.0 kg of acetone/special naphtha 60/95 (1:1) mixture. For reduction of the residual initiators, after 8 h and after 10 h in each case 90 g of bis(4-tert-butylcyclohexyl)peroxydicarbonate were added. The reaction was interrupted after a reaction time of 24 h and the mixture was cooled to room temperature. The polyacrylate was diluted with acetone to a solids content of 40.0 percent by weight. The solution obtained in this way is primer pressure-sensitive adhesive 3.

Primer Pressure-Sensitive Adhesive 4 for a Comparative Example

A conventional 100 l glass reactor for free radical polymerizations was filled with 15.4 kg of butyl acrylate, 24.4 kg of 2-ethylhexyl acrylate and 26.7 kg of acetone/special naphtha 60/95 (1:1). After passing nitrogen gas through for 45 minutes, while stirring, the reactor was heated up to 58° C. and 30 g of AIBN were added. The external heating bath was then heated to 75° C. and the reaction was carried out under constant conditions at this external temperature. After a reaction time of 1 h 30 g of AIBN were again added. After 4 and 8 h the mixture was diluted with in each case 10.0 kg of acetone/special naphtha 60/95 (1:1) mixture. For reduction of the residual initiators, after 8 h and after 10 h in each case 90 g of bis(4-tert-butylcyclohexyl)peroxydicarbonate were added. The reaction was interrupted after a reaction time of 24 h and the mixture was cooled to room temperature. The polyacrylate was diluted with acetone to a solids content of 40.0 percent by weight. The solution obtained in this way is primer pressure-sensitive adhesive 4.

Primer pressure-sensitive adhesives 1 to 4 were briefly characterized by DMA measurements. The G′ and G″ curves of primer pressure-sensitive adhesives 1 to 4 in the deformation frequency range of from 10⁰ to 10¹ rad/sec at 23° C. were always at least partly in the range of from 10³ to 10⁷ Pa.

The primer pressure-sensitive adhesives described above with respect to their preparation and composition and the following raw materials were used for the preparation of the primers according to the invention:

| Chemical compound/description | | Manufacturer | |
|---|---|---|---|
| (manufacturer's information) | Trade name | or supplier | CAS no. |
| N-Dimethoxy(methyl)silylmethyl-O- | Geniosil ®XL 65 | Wacker- | 23432-65-7 |
| methyl carbamate | | Chemie | |
| N-Trimethoxysilylmethyl-O-methyl | Geniosil ®XL 63 | Wacker- | 23432-64-6 |
| carbamate | | Chemie | |
| Methacryloxymethyl- | Geniosil ®XL 33 | Wacker- | 54586-78-6 |
| trimethoxysilane | | Chemie | |
| N-Cyclohexylaminomethyl- | Geniosil ®XL 926 | Wacker- | 26495-91-0 |
| triethoxysilane | | Chemie | |
| Titanium tetraisopropanolate | Tyzor ® TPT | Lehmann & | 546-68-9 |
| | | Voβ | |
| Tetra-n-butyl titanate | Tyzor ® TnBT | Lehmann & | 5593-70-4 |
| | | Voβ | |
| Bis(acetylacetonato) isobutyl | Tyzor ® AA-95 | Lehmann & | 97281-09-9 |
| isopropyl titanate | | Voβ | |
| Tetra-n-butyl zirconate | Tyzor ® NBZ | Lehmann & | 1071-76-7 |
| | | Voβ | |
| Ethylenediamine | | Sigma- | 107-15-3 |
| | | Aldrich | |
| Isophoronediamine | | Sigma- | 2855-13-2 |
| | | Aldrich | |
| Tosyl isocyanate | Additiv TI ® | OMG | 4083-64-1 |
| | | Borchers | |

The primers according to the invention were modified with the following raw materials for the preparation of the comparative examples and the less advantageous examples:

| Chemical compound/description | | Manufacturer |
|---|---|---|
| (manufacturer's information) | Trade name | or supplier |
| SBS block copolymer | Kraton ® D 1102 E | Kraton Polymers |
| Hydrogenated SEBS block | Kraton ® G 1652 E | Kraton Polymers |
| copolymer | | |
| Vinyltrimethoxysilane | Geniosil ® XL 10 | Wacker Chemie |
| (CAS-Nr.: 2768-02-7) | | |

In addition to the solvents contained in the primer pressure-sensitive adhesives, the following solvents were furthermore used for the preparation of the primers according to the invention:

| | | Manufacturer or |
|---|---|---|
| Name | CAS no. | supplier |
| Ethyl acetate | 141-78-6 | Brenntag |
| Acetone | 67-64-1 | Shell |
| Isopropanol | 67-63-0 | Sigma-Aldrich |

In addition to the solvents contained in the primer pressure-sensitive adhesives, the following solvent was used for the preparation of the non-advantageous examples:

| | | Manufacturer or |
|---|---|---|
| Name | CAS no. | supplier |
| Toluene | 108-88-3 | Sigma-Aldrich |

The following pigments and functional fillers were incorporated by way of example into the primers:

| Chemical | | | |
|---|---|---|---|
| compound/description | | | |
| (manufacturer's | | Manufacturer | |
| information) | Trade name | or supplier | CAS no. |
| Furnace black, oil | Printex ® 60 | Orion | 1333-86-4 |
| absorption number | | | |
| OAN: 118, BET | | | |
| surface area: 115 | | | |
| Furnace black, oil | Printex ® 3 | Orion | 1333-86-4 |
| absorption number | | | |
| OAN: 128, BET | | | |
| surface area: 80 | | | |
| Copper chromite black | Black 30C965 ® | Shepherd | 68186-91-4 |
| spinel C.I. Pigment | | | |
| Black 28 | | | |

The following fluorescent optical brighteners were furthermore also used:

| Chemical | | | |
|---|---|---|---|
| compound/description | | | |
| (manufacturer's | | Manufacturer | |
| information) | Trade name | or supplier | CAS no. |
| 2,5-Thiophenediylbis(5- | Tinopal OB ® | BASF | 7128-64-5 |
| tert-butyl-1,3-benzoxazole) | | | |

### EXAMPLES

The raw materials/components stated in the examples were mixed with a laboratory stirrer from IKA® using a propeller stirrer at a moderate speed of rotation. The raw materials were added here in the sequence as shown in the following tables. After the last solvent had been added, the mixture was stirred for 20 minutes. The mixture was then stirred for 10 minutes after each addition of the next particular raw material. After the last raw material had been added, the mixture was stirred for 30 minutes.

The pigments and rheological additives for achieving a fine-grained, opaque primer layer were incorporated in all the examples with the Ultra-Turrax® T50 laboratory dissolver from IKA®, which operates according to the rotor-stator principle, in a manner such that the pigment and where appropriate the further rheological additives were dispersed into the mixture of primer pressure-sensitive adhesive and solvents initially prepared. The Ultra-Turrax®T50 was operated here with a speed of rotation of 7,000 revolutions per minute. Dispersing was carried out for 30 minutes.

The remaining raw materials/components were then admixed in—in the sequence as shown in the following tables. The admixing in of these remaining raw materials/components was carried out with the laboratory stirrer from IKA® using a propeller stirrer.

The compositions of the primers comprising pigments and where appropriate rheological additives were modified compared to the compositions which did not comprise these substances to the effect that the weight contents of the silane, of the metal compound and of the amine were increased, while retaining the weight ratios of these substances to one another. The weight ratios of the other substance likewise remained unchanged with respect to on another.

### Example 1

Composition of the Primer:

| No. | Raw material/component | Percent by weight |
|---|---|---|
| 1 | Primer pressure-sensitive adhesive 1 | 19.55 |
| | (40.0 percent by weight solids content) | |
| 2 | Acetone | 25.25 |
| 3 | Isopropanol | 14.52 |
| 4 | Ethyl acetate | 33.51 |
| 5 | Tyzor ® TPT | 4.90 |
| 6 | Geniosil ® XL 65 | 2.01 |
| 7 | Ethylenediamine | 0.26 |

The flash-off time was 40 sec.

The primer was tested with the test adhesive tapes, the following results being obtained:

| | | | | | | | | | Test |
|---|---|---|---|---|---|---|---|---|---|
| | | | | | | | | | adhesive |
| | Test adhesive tape 1 | | Test adhesive tape 2 | | Test adhesive tape 3 | | Test adhesive tape 4 | | tape 5 |
| | Glass | Ceramic | Glass | Ceramic | Glass | Ceramic | Glass | Ceramic | Glass |
| Bonding time | 15 min | 1 h | 15 min | 1 h | 1 h | 1 h | 1 h | 1 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 15 sec (A) |
| achieve an | | | | | | | | | |
| adequate initial | | | | | | | | | |
| strength | | | | | | | | | |
| Time taken to | 30 sec | 60 sec | 15 sec | 30 sec | 15 sec | 15 sec | 15 sec | 30 sec | |
| achieve | | | | | | | | | |
| repositionability | | | | | | | | | |

C = cohesive = splitting of the foam in the adhesive tape
A = adhesive
h = hours
min = minutes
sec = seconds

### Example 1a

Composition of the primer with the coloured pigment Printex® 60:

| No. | Raw material/component | Percent by weight |
|---|---|---|
| 1 | Primer pressure-sensitive adhesive 1 | 17.50 |
| | (40.0 percent by weight solids content) | |
| 2 | Acetone | 22.60 |
| 3 | Isopropanol | 13.00 |
| 4 | Ethyl acetate | 30.00 |
| 5 | Printex ® 60 | 3.00 |
| 6 | Tyzor ® TPT | 9.50 |
| 7 | Geniosil ® XL 65 | 3.90 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 1, the same results being obtained.

### Example 1b

Composition of the primer with the coloured pigment Printex® 3:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 30.00 |
| 5 | Printex ® 3 | 3.00 |
| 6 | Tyzor ® TPT | 9.50 |
| 7 | Geniosil ® XL 65 | 3.90 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 1, the same results being obtained.

### Example 1c

Composition of the primer with the coloured pigment Black 30C965®:

| | | Percent |
|---|---|---|
| No. | Raw material/component | by weight |
| 1 | Primer pressure-sensitive adhesive 1 (40.0 percent by | 16.45 |
| | weight solids content) | |
| 2 | Acetone | 21.24 |
| 3 | Isopropanol | 12.22 |
| 4 | Ethyl acetate | 28.19 |
| 5 | Black 30C965 ® | 8.00 |
| 6 | Tyzor ® TPT | 9.50 |
| 7 | Geniosil ® XL 65 | 3.90 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 1, the same results being obtained.

### Example 2

Composition of the Primer:

| | | Percent |
|---|---|---|
| No. | Raw material/component | by weight |
| 1 | Primer pressure-sensitive adhesive 1 (40.0 percent by | 19.85 |
| | weight solids content) | |
| 2 | Acetone | 24.14 |
| 3 | Isopropanol | 14.75 |
| 4 | Ethyl acetate | 32.90 |
| 5 | Tyzor ® TPT | 6.09 |
| 6 | Geniosil ® XL 65 | 2.01 |
| 7 | Ethylenediamine | 0.26 |

The flash-off time was 30 sec.

The primer was tested with the test adhesive tapes, the following results being obtained:

| | | | | | | | | | Test |
|---|---|---|---|---|---|---|---|---|---|
| | | | | | | | | | adhesive |
| | Test adhesive tape 1 | | Test adhesive tape 2 | | Test adhesive tape 3 | | Test adhesive tape 4 | | tape 5 |
| | Glass | Ceramic | Glass | Ceramic | Glass | Ceramic | Glass | Ceramic | Glass |
| Bonding time | 12 h | 12 h | 12 h | 12 h | 24 h | 24 h | 12 h | 12 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 30 sec (A) |
| achieve an | | | | | | | | | |
| adequate initial | | | | | | | | | |
| strength | | | | | | | | | |
| Time taken to | 60 sec | 60 sec | 30 sec | 30 sec | 15 sec | 15 sec | 30 sec | 30 sec | |
| achieve | | | | | | | | | |
| repositionability | | | | | | | | | |

C = cohesive = splitting of the foam in the adhesive tape
A = adhesive
h = hours
min = minutes
sec = seconds

### Example 2a

Composition of the Primer with the Coloured Pigment Printex® 60:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 21.28 |
| 3 | Isopropanol | 13.00 |
| 4 | Ethyl acetate | 29.00 |
| 5 | Printex ® 60 | 3.00 |
| 6 | Tyzor ® TPT | 11.82 |
| 7 | Geniosil ® XL 65 | 3.90 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 2, the same results being obtained.

### Example 2b

Composition of the Primer with the Coloured Pigment Printex® 3:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 21.28 |
| 3 | Isopropanol | 13.00 |
| 4 | Ethyl acetate | 29.00 |
| 5 | Printex ® 3 | 3.00 |
| 6 | Tyzor ® TPT | 11.82 |
| 7 | Geniosil ® XL 65 | 3.90 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 2, the same results being obtained.

### Example 2c

Composition of the primer with the coloured pigment Black 30C965®:

| | | Percent |
|---|---|---|
| No. | Raw material/component | by weight |
| 1 | Primer pressure-sensitive adhesive 1 (40.0 percent by | 16.42 |
| | weight solids content) | |
| 2 | Acetone | 19.96 |
| 3 | Isopropanol | 12.20 |
| 4 | Ethyl acetate | 27.21 |
| 5 | Black 30C965 ® | 8.00 |
| 6 | Tyzor ® TPT | 11.82 |
| 7 | Geniosil ® XL 65 | 3.90 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 2, the same results being obtained.

### Example 3

Composition of the Primer:

| | | Percent |
|---|---|---|
| No. | Raw material/component | by weight |
| 1 | Primer pressure-sensitive adhesive 1 (40.0 percent by | 19.63 |
| | weight solids content) | |
| 2 | Acetone | 25.35 |
| 3 | Isopropanol | 14.58 |
| 4 | Ethyl acetate | 32.96 |
| 5 | Tyzor ® TPT | 4.90 |
| 6 | Geniosil ® XL 63 | 2.32 |
| 7 | Ethylenediamine | 0.26 |

The flash-off time was 40 sec.

The primer was tested with the test adhesive tapes, the following results being obtained:

| | | | | | | | | | Test |
|---|---|---|---|---|---|---|---|---|---|
| | | | | | | | | | adhesive |
| | Test adhesive tape 1 | | Test adhesive tape 2 | | Test adhesive tape 3 | | Test adhesive tape 4 | | tape 5 |
| | Glass | Ceramic | Glass | Ceramic | Glass | Ceramic | Glass | Ceramic | Glass |
| Bonding time | 1 h | 1 h | 30 min | 1 h | 1 h | 1 h | 1 h | 1 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 60 sec (A) |
| achieve an | | | | | | | | | |
| adequate initial | | | | | | | | | |
| strength | | | | | | | | | |
| Time taken to | 30 sec | 60 sec | 15 sec | 60 sec | 15 sec | 15 sec | 30 sec | 30 sec | |
| achieve | | | | | | | | | |
| repositionability | | | | | | | | | |

C = cohesive = splitting of the foam in the adhesive tape
A = adhesive
h = hours
min = minutes
sec = seconds

### Example 3a

Composition of the Primer with the Coloured Pigment Printex® 60:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 29.40 |
| 5 | Printex ® 60 | 3.00 |
| 6 | Tyzor ® TPT | 9.50 |
| 7 | Geniosil ® XL 63 | 4.50 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 3, the same results being obtained.

### Example 3b

Composition of the Primer with the Coloured Pigment Printex® 3:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 29.40 |
| 5 | Printex ® 3 | 3.00 |
| 6 | Tyzor ® TPT | 9.50 |
| 7 | Geniosil ® XL 63 | 4.50 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 3, the same results being obtained.

### Example 3c

Composition of the Primer with the Coloured Pigment Black 30C965®:

| | | Percent |
|---|---|---|
| No. | Raw material/component | by weight |
| 1 | Primer pressure-sensitive adhesive 1 (40.0 percent by | 16.44 |
| | weight solids content) | |
| 2 | Acetone | 21.23 |
| 3 | Isopropanol | 12.21 |
| 4 | Ethyl acetate | 27.62 |
| 5 | Black 30C965 ® | 8.00 |
| 6 | Tyzor ® TPT | 9.50 |
| 7 | Geniosil ® XL 63 | 4.50 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 3, the same results being obtained.

### Example 4

Composition of the Primer:

| | | Percent |
|---|---|---|
| No. | Raw material/component | by weight |
| 1 | Primer pressure-sensitive adhesive 1 (40.0 percent by | 19.63 |
| | weight solids content) | |
| 2 | Acetone | 25.35 |
| 3 | Isopropanol | 14.58 |
| 4 | Ethyl acetate | 32.96 |
| 5 | Tyzor ® TPT | 4.90 |
| 6 | Geniosil ® XL 33 | 2.32 |
| 7 | Ethylenediamine | 0.26 |

The flash-off time was 40 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | 12 h | 12 h | 1 h | 12 h | 12 h | 12 h | 12 h | 12 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 240 sec |
| achieve an | | | | | | | | | (A) |
| adequate initial | | | | | | | | | |
| strength | | | | | | | | | |
| Time taken to | 240 sec | 180 sec | 180 sec | 120 sec | 120 sec | 90 sec | 180 sec | 120 sec | |
| achieve | | | | | | | | | |
| repositionability | | | | | | | | | |

C = cohesive = splitting of the foam in the adhesive tape
A = adhesive
h = hours
min = minutes
sec = seconds

### Example 4a

Composition of the Primer with the Coloured Pigment Printex® 60:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 29.40 |
| 5 | Printex ® 60 | 3.00 |
| 6 | Tyzor ® TPT | 9.50 |
| 7 | Geniosil ® XL 33 | 4.50 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 4, the same results being obtained.

### Example 4b

Composition of the Primer with the Coloured Pigment Printex® 3:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 29.40 |
| 5 | Printex ® 3 | 3.00 |
| 6 | Tyzor ® TPT | 9.50 |
| 7 | Geniosil ® XL 33 | 4.50 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 4, the same results being obtained.

### Example 5

Composition of the Primer:

| | | Percent |
|---|---|---|
| No. | Raw material/component | by weight |
| 1 | Primer pressure-sensitive adhesive 1 (40.0 percent by | 19.52 |
| | weight solids content) | |
| 2 | Acetone | 25.21 |
| 3 | Isopropanol | 14.50 |
| 4 | Ethyl acetate | 33.70 |
| 5 | Tyzor ® TPT | 3.97 |
| 6 | Geniosil ® XL 926 | 2.89 |
| 7 | Ethylenediamine | 0.21 |

The flash-off time was 40 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | 12 h | 12 h | 1 h | 12 h | 12 h | 12 h | 12 h | 12 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 120 sec |
| achieve an | | | | | | | | | (A) |
| adequate initial | | | | | | | | | |
| strength | | | | | | | | | |
| Time taken to | 240 sec | 180 sec | 180 sec | 120 sec | 120 sec | 90 sec | 180 sec | 120 sec | |
| achieve | | | | | | | | | |
| repositionability | | | | | | | | | |

C = cohesive = splitting of the foam in the adhesive tape
A = adhesive
h = hours
min = minutes
sec = seconds

### Example 5a

Composition of the Primer with the Coloured Pigment Printex® 60:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 30.20 |
| 5 | Printex ® 60 | 3.00 |
| 6 | Tyzor ® TPT | 7.70 |
| 7 | Geniosil ® XL 926 | 5.60 |
| 8 | Ethylenediamine | 0.40 |

A 10 μm thick layer of this primer on glass was opaque. The transmission in the wavelength range of from 300 nm to 850 nm was 0%.

The primer was tested in the same manner as the pigment-free primer from Example 5, the same results being obtained.

### Example 5b

Composition of the Primer with the Coloured Pigment Printex® 3:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 30.20 |
| 5 | Printex ® 3 | 3.00 |
| 6 | Tyzor ® TPT | 7.70 |
| 7 | Geniosil ® XL 926 | 5.60 |
| 8 | Ethylenediamine | 0.40 |

A 10 μm thick layer of this primer on glass was opaque. The transmission in the wavelength range of from 300 nm to 850 nm was 0%.

The primer was tested in the same manner as the pigment-free primer from Example 5, the same results being obtained.

### Example 6

Composition of the Primer:

| | | Percent |
|---|---|---|
| No. | Raw material/component | by weight |
| 1 | Primer pressure-sensitive adhesive 1 (40.0 percent by | 19.61 |
| | weight solids content) | |
| 2 | Acetone | 25.32 |
| 3 | Isopropanol | 14.56 |
| 4 | Ethyl acetate | 33.12 |
| 5 | Tyzor ® TnBT | 5.15 |
| 6 | Geniosil ® XL 65 | 2.01 |
| 7 | Ethylenediamine | 0.23 |

The flash-off time was 35 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | 30 min | 1 h | 30 min | 30 min | 1 h | 1 h | 30 min | 1 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 30 sec |
| achieve an | | | | | | | | | (A) |
| adequate initial | | | | | | | | | |
| strength | | | | | | | | | |
| Time taken to | 60 sec | 60 sec | 30 sec | 30 sec | 15 sec | 15 sec | 30 sec | 30 sec | |
| achieve | | | | | | | | | |
| repositionability | | | | | | | | | |

C = cohesive = splitting of the foam in the adhesive tape
A = adhesive
h = hours
min = minutes
sec = seconds

### Example 6a

Composition of the Primer with the Coloured Pigment Printex® 60:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 29.56 |
| 5 | Printex ® 60 | 3.00 |
| 6 | Tyzor ® TnBT | 10.00 |
| 7 | Geniosil ® XL 65 | 3.90 |
| 8 | Ethylenediamine | 0.44 |

A 10 μm thick layer of this primer on glass was opaque. The transmission in the wavelength range of from 300 nm to 850 nm was 0%.

The primer was tested in the same manner as the pigment-free primer from Example 6, the same results being obtained.

### Example 6b

Composition of the Primer with the Coloured Pigment Printex® 3:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 29.56 |
| 5 | Printex ® 3 | 3.00 |
| 6 | Tyzor ® TnBT | 10.00 |
| 7 | Geniosil ® XL 65 | 3.90 |
| 8 | Ethylenediamine | 0.44 |

A 10 μm thick layer of this primer on glass was opaque. The transmission in the wavelength range of from 300 nm to 850 nm was 0%.

The primer was tested in the same manner as the pigment-free primer from Example 6, the same results being obtained.

### Example 7

Composition of the Primer:

| | | Percent |
|---|---|---|
| No. | Raw material/component | by weight |
| 1 | Primer pressure-sensitive adhesive 1 (40.0 percent by | 19.73 |
| | weight solids content) | |
| 2 | Acetone | 25.48 |
| 3 | Isopropanol | 14.66 |
| 4 | Ethyl acetate | 32.24 |
| 5 | Tyzor ® AA-95 | 5.67 |
| 6 | Geniosil ® XL 65 | 2.01 |
| 7 | Ethylenediamine | 0.21 |

The flash-off time was 35 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | 12 h | 1 h | 1 h | 12 h | 12 h | 12 h | 12 h | 1 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 120 sec |
| achieve an | | | | | | | | | (A) |
| adequate initial | | | | | | | | | |
| strength | | | | | | | | | |
| Time taken to | 120 sec | 60 sec | 120 sec | 120 sec | 30 sec | 60 sec | 120 sec | 60 sec | |
| achieve | | | | | | | | | |
| repositionability | | | | | | | | | |

C = cohesive = splitting of the foam in the adhesive tape
A = adhesive
h = hours
min = minutes
sec = seconds

### Example 7a

Composition of the Primer with the Coloured Pigment Printex® 60:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 28.60 |
| 5 | Printex ® 60 | 3.00 |
| 6 | Tyzor ® AA-95 | 11.00 |
| 7 | Geniosil ® XL 65 | 3.90 |
| 8 | Ethylenediamine | 0.40 |

A 10 μm thick layer of this primer on glass was opaque. The transmission in the wavelength range of from 300 nm to 850 nm was 0%.

The primer was tested in the same manner as the pigment-free primer from Example 7, the same results being obtained.

### Example 7b

Composition of the Primer with the Coloured Pigment Printex® 3:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 28.60 |
| 5 | Printex ® 3 | 3.00 |
| 6 | Tyzor ® AA-95 | 11.00 |
| 7 | Geniosil ® XL 65 | 3.90 |
| 8 | Ethylenediamine | 0.40 |

A 10 μm thick layer of this primer on glass was opaque. The transmission in the wavelength range of from 300 nm to 850 nm was 0%.

The primer was tested in the same manner as the pigment-free primer from Example 7, the same results being obtained.

### Example 8

Composition of the Primer:

| | | Percent |
|---|---|---|
| No. | Raw material/component | by weight |
| 1 | Primer pressure-sensitive adhesive 1 (40.0 percent by | 19.73 |
| | weight solids content) | |
| 2 | Acetone | 25.49 |
| 3 | Isopropanol | 14.66 |
| 4 | Ethyl acetate | 32.22 |
| 5 | Tyzor ® NBZ | 5.67 |
| 6 | Geniosil ® XL 65 | 2.01 |
| 7 | Ethylenediamine | 0.22 |

The flash-off time was 35 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | 1 h | 1 h | 15 min | 1 h | 1 h | 1 h | 1 h | 1 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 30 sec |
| achieve an | | | | | | | | | (A) |
| adequate initial | | | | | | | | | |
| strength | | | | | | | | | |
| Time taken to | 60 sec | 60 sec | 15 sec | 30 sec | 30 sec | 15 sec | 30 sec | 30 sec | |
| achieve | | | | | | | | | |
| repositionability | | | | | | | | | |

C = cohesive = splitting of the foam in the adhesive tape
A = adhesive
h = hours
min = minutes
sec = seconds

### Example 8a

Composition of the Primer with the Coloured Pigment Printex® 60:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 28.57 |
| 5 | Printex ® 60 | 3.00 |
| 6 | Tyzor ® NBZ | 11.00 |
| 7 | Geniosil ® XL 65 | 3.90 |
| 8 | Ethylenediamine | 0.43 |

A 10 μm thick layer of this primer on glass was opaque. The transmission in the wavelength range of from 300 nm to 850 nm was 0%.

The primer was tested in the same manner as the pigment-free primer from Example 8, the same results being obtained.

### Example 8b

Composition of the Primer with the Coloured Pigment Printex® 3:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 28.57 |
| 5 | Printex ® 3 | 3.00 |
| 6 | Tyzor ® NBZ | 11.00 |
| 7 | Geniosil ® XL 65 | 3.90 |
| 8 | Ethylenediamine | 0.43 |

A 10 μm thick layer of this primer on glass was opaque. The transmission in the wavelength range of from 300 nm to 850 nm was 0%.

The primer was tested in the same manner as the pigment-free primer from Example 8, the same results being obtained.

### Example 9

Composition of the Primer:

| | | Percent |
|---|---|---|
| No. | Raw material/component | by weight |
| 1 | Primer pressure-sensitive adhesive 1 (40.0 percent by | 19.35 |
| | weight solids content) | |
| 2 | Acetone | 24.98 |
| 3 | Isopropanol | 14.38 |
| 4 | Ethyl acetate | 34.94 |
| 5 | Tyzor ® TPT | 3.87 |
| 6 | Geniosil ® XL 65 | 1.91 |
| 7 | Isophoronediamine | 0.57 |

The flash-off time was 40 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | 12 h | 24 h | 12 h | 12 h | 24 h | 12 h | 12 h | 12 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 120 sec |
| achieve an | | | | | | | | | (A) |
| adequate initial | | | | | | | | | |
| strength | | | | | | | | | |
| Time taken to | 120 sec | 180 sec | 120 sec | 120 sec | 60 sec | 60 sec | 120 sec | 120 sec | |
| achieve | | | | | | | | | |
| repositionability | | | | | | | | | |

C = cohesive = splitting of the foam in the adhesive tape
A = adhesive
h = hours
min = minutes
sec = seconds

### Example 9a

Composition of the Primer with the Coloured Pigment Printex® 60:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 31.60 |
| 5 | Printex ® 60 | 3.00 |
| 6 | Tyzor ® TPT | 7.50 |
| 7 | Geniosil ® XL 65 | 3.70 |
| 8 | Isophoronediamine | 1.10 |

A 10 μm thick layer of this primer on glass was opaque. The transmission in the wavelength range of from 300 nm to 850 nm was 0%.

The primer was tested in the same manner as the pigment-free primer from Example 9, the same results being obtained.

### Example 9b

Composition of the Primer with the Coloured Pigment Printex® 3:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 22.60 |
| 3 | Isopropanol | 13.00 |
| 4 | Ethyl acetate | 31.60 |
| 5 | Printex ® 3 | 3.00 |
| 6 | Tyzor ® TPT | 7.50 |
| 7 | Geniosil ® XL 65 | 3.70 |
| 8 | Isophoronediamine | 1.10 |

A 10 μm thick layer of this primer on glass was opaque. The transmission in the wavelength range of from 300 nm to 850 nm was 0%.

The primer was tested in the same manner as the pigment-free primer from Example 9, the same results being obtained.

### Example 10

Composition of the Primer:

| | | Percent |
|---|---|---|
| No. | Raw material/component | by weight |
| 1 | Primer pressure-sensitive adhesive 1 (40.0 percent by | 20.09 |
| | weight solids content) | |
| 2 | Acetone | 23.07 |
| 3 | Isopropanol | 14.92 |
| 4 | Ethyl acetate | 32.67 |
| 5 | Tyzor ® TPT | 4.38 |
| 6 | Geniosil ® XL 65 | 2.06 |
| 7 | Ethylenediamine | 0.23 |
| 8 | Additiv TI ® | 2.58 |

The flash-off time was 40 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | 1 h | 1 h | 15 min | 1 h | 1 h | 1 h | 1 h | 1 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 60 sec |
| achieve an | | | | | | | | | (A + C) |
| adequate initial | | | | | | | | | |
| strength | | | | | | | | | |
| Time taken to | 90 sec | 90 sec | 60 sec | 60 sec | 30 sec | 30 sec | 60 sec | 60 sec | |
| achieve | | | | | | | | | |
| repositionability | | | | | | | | | |

C = cohesive = splitting of the foam in the adhesive tape
A = adhesive
h = hours
min = minutes
sec = seconds

### Example 10a

Composition of the Primer with the Coloured Pigment Printex® 60:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 20.10 |
| 3 | Isopropanol | 13.00 |
| 4 | Ethyl acetate | 28.46 |
| 5 | Printex ® 60 | 3.00 |
| 6 | Tyzor ® TPT | 8.50 |
| 7 | Geniosil ® XL 65 | 4.00 |
| 8 | Ethylenediamine | 0.44 |
| 9 | Additiv TI ® | 5.00 |

A 10 μm thick layer of this primer on glass was opaque. The transmission in the wavelength range of from 300 nm to 850 nm was 0%.

The primer was tested in the same manner as the pigment-free primer from Example 10, the same results being obtained.

### Example 10b

Composition of the Primer with the Coloured Pigment Printex® 3:

| | | Percent |
|---|---|---|
| No. | Raw material/component | by weight |
| 1 | Primer pressure-sensitive adhesive 1 (40.0 percent by | 17.50 |
| | weight solids content) | |
| 2 | Acetone | 20.10 |
| 3 | Isopropanol | 13.00 |
| 4 | Ethyl acetate | 28.46 |
| 5 | Printex ® 3 | 3.00 |
| 6 | Tyzor ® TPT | 8.50 |
| 7 | Geniosil ® XL 65 | 4.00 |
| 8 | Ethylenediamine | 0.44 |
| 9 | Additiv TI ® | 5.00 |

A 10 μm thick layer of this primer on glass was opaque. The transmission in the wavelength range of from 300 nm to 850 nm was 0%.

The primer was tested in the same manner as the pigment-free primer from Example 10, the same results being obtained.

### Example 11

Composition of the Primer:

| | | Percent |
|---|---|---|
| No. | Raw material/component | by weight |
| 1 | Primer pressure-sensitive adhesive 2 (40.0 percent by | 19.55 |
| | weight solids content) | |
| 2 | Acetone | 25.25 |
| 3 | Isopropanol | 14.52 |
| 4 | Ethyl acetate | 33.51 |
| 5 | Tyzor ® TPT | 4.90 |
| 6 | Geniosil ® XL 65 | 2.01 |
| 7 | Ethylenediamine | 0.26 |

The flash-off time was 40 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | 1 h | 1 h | 1 h | 1 h | 1 h | 1 h | 1 h | 1 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 60 sec |
| achieve an | | | | | | | | | (A) |
| adequate initial | | | | | | | | | |
| strength | | | | | | | | | |
| Time taken to | 120 sec | 180 sec | 120 sec | 120 sec | 60 sec | 60 sec | 120 sec | 120 sec | |
| achieve | | | | | | | | | |
| repositionability | | | | | | | | | |

C = cohesive = splitting of the foam in the adhesive tape
A = adhesive
h = hours
min = minutes
sec = seconds

### Example 11a

Composition of the Primer with the Coloured Pigment Printex® 60:

| | | Percent |
|---|---|---|
| No. | Raw material/component | by weight |
| 1 | Primer pressure-sensitive adhesive 2 (40.0 percent by | 17.50 |
| | weight solids content) | |
| 2 | Acetone | 22.60 |
| 3 | Isopropanol | 13.00 |
| 4 | Ethyl acetate | 30.00 |
| 5 | Printex ® 60 | 3.00 |
| 6 | Tyzor ® TPT | 9.50 |
| 7 | Geniosil ® XL 65 | 3.90 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 11, the same results being obtained.

### Example 11b

Composition of the Primer with the Coloured Pigment Printex® 3:

| | | Percent |
|---|---|---|
| No. | Raw material/component | by weight |
| 1 | Primer pressure-sensitive adhesive 2 (40.0 percent by | 17.50 |
| | weight solids content) | |
| 2 | Acetone | 22.60 |
| 3 | Isopropanol | 13.00 |
| 4 | Ethyl acetate | 30.00 |
| 5 | Printex ® 3 | 3.00 |
| 6 | Tyzor ® TPT | 9.50 |
| 7 | Geniosil ® XL 65 | 3.90 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 11, the same results being obtained.

### Example 12

Composition of the Primer:

| | | Percent |
|---|---|---|
| No. | Raw material/component | by weight |
| 1 | Primer pressure-sensitive adhesive 3 (40.0 percent by | 19.55 |
| | weight solids content) | |
| 2 | Acetone | 25.25 |
| 3 | Isopropanol | 14.52 |
| 4 | Ethyl acetate | 33.51 |
| 5 | Tyzor ® TPT | 4.90 |
| 6 | Geniosil ® XL 65 | 2.01 |
| 7 | Ethylenediamine | 0.26 |

The flash-off time was 40 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | 1 h | 12 h | 1 h | 12 h | 12 h | 12 h | 1 h | 1 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 120 sec |
| achieve an | | | | | | | | | (A) |
| adequate initial | | | | | | | | | |
| strength | | | | | | | | | |
| Time taken to | 180 sec | 180 sec | 180 sec | 180 sec | 60 sec | 60 sec | 180 sec | 180 sec | |
| achieve | | | | | | | | | |
| repositionability | | | | | | | | | |

C = cohesive = splitting of the foam in the adhesive tape
A = adhesive
h = hours
min = minutes
sec = seconds

### Example 12a

Composition of the Primer with the Coloured Pigment Printex® 60:

| | | Percent |
|---|---|---|
| No. | Raw material/component | by weight |
| 1 | Primer pressure-sensitive adhesive 3 (40.0 percent by | 17.50 |
| | weight solids content) | |
| 2 | Acetone | 22.60 |
| 3 | Isopropanol | 13.00 |
| 4 | Ethyl acetate | 30.00 |
| 5 | Printex ® 60 | 3.00 |
| 6 | Tyzor ® TPT | 9.50 |
| 7 | Geniosil ® XL 65 | 3.90 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 12, the same results being obtained.

### Example 12b

Composition of the Primer with the Coloured Pigment Printex® 3:

| | | Percent |
|---|---|---|
| No. | Raw material/component | by weight |
| 1 | Primer pressure-sensitive adhesive 3 (40.0 percent by | 17.50 |
| | weight solids content) | |
| 2 | Acetone | 22.60 |
| 3 | Isopropanol | 13.00 |
| 4 | Ethyl acetate | 30.00 |
| 5 | Printex ® 3 | 3.00 |
| 6 | Tyzor ® TPT | 9.50 |
| 7 | Geniosil ® XL 65 | 3.90 |
| 8 | Ethylenediamine | 0.50 |

A 10 μm thick layer of this primer on glass was opaque. The transmission in the wavelength range of from 300 nm to 850 nm was 0%.

The primer was tested in the same manner as the pigment-free primer from Example 12, the same results being obtained.

### Example 13

Composition of the Primer:

| | | Percent |
|---|---|---|
| No. | Raw material/component | by weight |
| 1 | Primer pressure-sensitive adhesive 1 (40.0 percent by | 19.55 |
| | weight solids content) | |
| 2 | Acetone | 25.25 |
| 3 | Isopropanol | 14.52 |
| 4 | Ethyl acetate | 33.36 |
| 5 | Tyzor ® TPT | 4.90 |
| 6 | Geniosil ® XL 65 | 2.01 |
| 7 | Ethylenediamine | 0.26 |
| 8 | Tinopal OB ® | 0.15 |

The flash-off time was 40 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | 15 min | 1 h | 15 min | 1 h | 1 h | 1 h | 1 h | 1 h | |
| until the foam | | | | | | | | | |
| splits | | | | | | | | | |
| Fracture pattern | C | C | C | C | C | C | C | C | |
| after climate | | | | | | | | | |
| storage a) | | | | | | | | | |
| Fracture pattern | C | C | C | C | C | C | C | C | |
| after climate | | | | | | | | | |
| storage b) | | | | | | | | | |
| Time taken to | | | | | | | | | 15 sec |
| achieve an | | | | | | | | | (A) |
| adequate initial | | | | | | | | | |
| strength | | | | | | | | | |
| Time taken to | 30 sec | 60 sec | 15 sec | 30 sec | 15 sec | 15 sec | 15 sec | 30 sec | |
| achieve | | | | | | | | | |
| repositionability | | | | | | | | | |

C = cohesive = splitting of the foam in the adhesive tape
A = adhesive
h = hours
min = minutes
sec = seconds

### Example 14

Composition of the Primer:

| | | Percent |
|---|---|---|
| No. | Raw material/component | by weight |
| 1 | Primer pressure-sensitive adhesive 1 (40.0 percent by | 19.74 |
| | weight solids content) | |
| 2 | toluene | 55.40 |
| 3 | Ethyl acetate | 16.92 |
| 4 | Tyzor ® TPT | 4.90 |
| 5 | Geniosil ® XL 65 | 2.01 |
| 6 | Ethylenediamine | 0.26 |
| 7 | Kraton ® D 1102 E | 0.77 |

The flash-off time was 150 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | 48 h | 48 h | 48 h | 48 h | 48 h | 48 h | 48 h | 48 h | |
| until the foam | (A and C) | (A and C) | (A and C) | (A and C) | (A and C) | (A and C) | (A and C) | (A and C) | |
| splits | | | | | | | | | |
| Fracture pattern | A and C | A and C | A and C | A and C | A and C | A and C | A and C | A and C | |
| after climate | | | | | | | | | |
| storage a) | | | | | | | | | |
| Fracture pattern | A and C | A and C | A and C | A and C | A and C | A and C | A and C | A and C | |
| after climate | | | | | | | | | |
| storage b) | | | | | | | | | |
| Time taken to | | | | | | | | | 120 sec |
| achieve an | | | | | | | | | (A) |
| adequate initial | | | | | | | | | |
| strength | | | | | | | | | |
| Time taken to | 90 sec | 120 sec | 90 sec | 120 sec | 60 sec | 60 sec | 90 sec | 90 sec | |
| achieve | | | | | | | | | |
| repositionability | | | | | | | | | |

C = cohesive = splitting of the foam in the adhesive tape
A = adhesive
h = hours
min = minutes
sec = seconds

### Example 14a

Composition of the Primer with the Coloured Pigment Printex® 60:

| | | Percent |
|---|---|---|
| No. | Raw material/component | by weight |
| 1 | Primer pressure-sensitive adhesive 1 (40.0 percent by | 17.50 |
| | weight solids content) | |
| 2 | toluene | 49.10 |
| 3 | Ethyl acetate | 15.00 |
| 4 | Printex ® 60 | 3.00 |
| 5 | Tyzor ® TPT | 9.50 |
| 6 | Geniosil ® XL 65 | 3.90 |
| 7 | Ethylenediamine | 0.50 |
| 8 | Kraton ® D 1102 E | 1.5 |

A 10 μm thick layer of this primer on glass was opaque. The transmission in the wavelength range of from 300 nm to 850 nm was 0%.

The primer was tested in the same manner as the pigment-free primer from Example 14, the same results being obtained.

### Example 15

Composition of the Primer:

| | | Percent |
|---|---|---|
| No. | Raw material/component | by weight |
| 1 | Primer pressure-sensitive adhesive 1 (40.0 percent by | 19.74 |
| | weight solids content) | |
| 2 | toluene | 55.40 |
| 3 | Ethyl acetate | 16.92 |
| 4 | Tyzor ® TPT | 4.90 |
| 5 | Geniosil ® XL 65 | 2.01 |
| 6 | Ethylenediamine | 0.26 |
| 7 | Kraton ® G 1652 E | 0.77 |

The flash-off time was 160 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | 48 h | 48 h | 48 h | 48 h | 48 h | 48 h | 48 h | 48 h | |
| until the foam | (A and C) | (A and C) | (A and C) | (A and C) | (A and C) | (A and C) | (A and C) | (A and C) | |
| splits | | | | | | | | | |
| Fracture pattern | A and C | A and C | A and C | A and C | A and C | A and C | A and C | A and C | |
| after climate | | | | | | | | | |
| storage a) | | | | | | | | | |
| Fracture pattern | A and C | A and C | A and C | A and C | A and C | A and C | A and C | A and C | |
| after climate | | | | | | | | | |
| storage b) | | | | | | | | | |
| Time taken to | | | | | | | | | 180 sec |
| achieve an | | | | | | | | | (A) |
| adequate initial | | | | | | | | | |
| strength | | | | | | | | | |
| Time taken to | 120 sec | 120 sec | 120 sec | 120 sec | 60 sec | 60 sec | 90 sec | 90 sec | |
| achieve | | | | | | | | | |
| repositionability | | | | | | | | | |

C = cohesive = splitting of the foam in the adhesive tape
A = adhesive
h = hours
min = minutes
sec = seconds

### Example 15a

Composition of the Primer with the Coloured Pigment Printex® 60:

| | | Percent |
|---|---|---|
| No. | Raw material/component | by weight |
| 1 | Primer pressure-sensitive adhesive 1 (40.0 percent by | 17.50 |
| | weight solids content) | |
| 2 | toluene | 49.10 |
| 3 | Ethyl acetate | 15.00 |
| 4 | Printex ® 60 | 3.00 |
| 5 | Tyzor ® TPT | 9.50 |
| 6 | Geniosil ® XL 65 | 3.90 |
| 7 | Ethylenediamine | 0.50 |
| 8 | Kraton ® G 1652 E | 1.5 |

A 10 μm thick layer of this primer on glass was opaque. The transmission in the wavelength range of from 300 nm to 850 nm was 0%.

The primer was tested in the same manner as the pigment-free primer from Example 15, the same results being obtained.

### Comparative Example 1

Composition of the Comparison Primer:

| | | Percent |
|---|---|---|
| No. | Raw material/component | by weight |
| 1 | Primer pressure-sensitive adhesive 4 (40.0 percent by | 19.55 |
| | weight solids content) | |
| 2 | Acetone | 25.25 |
| 3 | Isopropanol | 14.52 |
| 4 | Ethyl acetate | 33.51 |
| 5 | Tyzor ® TPT | 4.90 |
| 6 | Geniosil ® XL 65 | 2.01 |
| 7 | Ethylenediamine | 0.26 |

The flash-off time was 40 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | >48 h | >48 h | >48 h | >48 h | >48 h | >48 h | >48 h | >48 h | |
| until the foam | | | | | | | | | |
| splits | | | | | | | | | |
| Time taken to | | | | | | | | | >240 min |
| achieve an | | | | | | | | | |
| adequate initial | | | | | | | | | |
| strength | | | | | | | | | |
| Time taken to | >240 min | >240 min | >240 min | >240 min | >240 min | >240 min | >240 min | >240 min | |
| achieve | | | | | | | | | |
| repositionability | | | | | | | | | |

C = cohesive = splitting of the foam in the adhesive tape
A = adhesive
h = hours
min = minutes
sec = seconds

### Comparative Example 2

Composition of the Comparison Primer:

| | | Percent |
|---|---|---|
| No. | Raw material/component | by weight |
| 1 | Primer pressure-sensitive adhesive 1 (40.0 percent by | 19.55 |
| | weight solids content) | |
| 2 | Acetone | 25.25 |
| 3 | Isopropanol | 14.52 |
| 4 | Ethyl acetate | 33.77 |
| 5 | Tyzor ® TPT | 4.90 |
| 6 | Geniosil ® XL 65 | 2.01 |

The flash-off time was 40 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | >48 h | >48 h | >48 h | >48 h | >48 h | >48 h | >48 h | >48 h | |
| until the foam | | | | | | | | | |
| splits | | | | | | | | | |
| Time taken to | | | | | | | | | >240 min |
| achieve an | | | | | | | | | |
| adequate initial | | | | | | | | | |
| strength | | | | | | | | | |
| Time taken to | >240 min | >240 min | >240 min | >240 min | >240 min | >240 min | >240 min | >240 min | |
| achieve | | | | | | | | | |
| repositionability | | | | | | | | | |

C = cohesive = splitting of the foam in the adhesive tape
A = adhesive
h = hours
min = minutes
sec = seconds

### Comparative Example 3

Composition of the Comparison Primer:

| | | Percent |
|---|---|---|
| No. | Raw material/component | by weight |
| 1 | Primer pressure-sensitive adhesive 4 (40.0 percent by | 19.55 |
| | weight solids content) | |
| 2 | Acetone | 25.25 |
| 3 | Isopropanol | 14.52 |
| 4 | Ethyl acetate | 33.51 |
| 5 | Tyzor ® TPT | 4.90 |
| 6 | Geniosil ® XL 10 | 2.01 |
| 7 | Ethylenediamine | 0.26 |

The flash-off time was 40 sec.

The primer was tested with the test adhesive tapes, the following results being obtained:

| | Test adhesive | | Test adhesive | | Test adhesive | | Test adhesive | | Test adhesive |
|---|---|---|---|---|---|---|---|---|---|
| | tape 1 | | tape 2 | | tape 3 | | tape 4 | | tape 5 |
| | Glass | Ceramic | Glass | Ceramic | Glass | Ceramic | Glass | Ceramic | Glass |
| Bonding time | >48 h | >48 h | >48 h | >48 h | >48 h | >48 h | >48 h | >48 h | |
| until the foam | | | | | | | | | |
| splits | | | | | | | | | |
| Time taken to | | | | | | | | | >240 min |
| achieve an | | | | | | | | | |
| adequate initial | | | | | | | | | |
| strength | | | | | | | | | |
| Time taken to | >240 min | >240 min | >240 min | >240 min | >240 min | >240 min | >240 min | >240 min | |
| achieve | | | | | | | | | |
| repositionability | | | | | | | | | |

C = cohesive = splitting of the foam in the adhesive tape
A = adhesive
h = hours
min = minutes
sec = seconds

1. A primer composition comprising, one or more solvents having dissolved or dispersed therein a mixture G which comprises the following constituents:
at least one copolymer obtained by copolymerization of a monomer mixture comprising to at least 90 wt. % the following monomers: vinylcaprolactam and/or vinylpyrrolidone and one or more of the monomers a) and b):
b) acrylic acid ester of a linear, primary alcohol having 2 to 10 carbon atoms in the alkyl radical of the alcohol,
c) acrylic acid ester of a branched, non-cyclic alcohol having 3 to 12 carbon atoms in the alkyl radical of the alcohol,
at least one organofunctional silane of the general structure (Ia) or (Ib)
(R¹O—)ₓSi(CH₂OR²)_{y}(R³)_{z} (Ia)
(R¹O—)ₓSi(CH₂NHR²)_{y}(R³)_{z} (Ib), wherein
the radicals R¹ independently of each other represent a C₁-C₄-alkyl radical, a C₂-C₆-alkoxyalkyl radical or an acetyl radical;
the radicals R² independently of each other represent an organic radical;
the radicals R³ independently of each other represent a C₁-C₁₈-alkyl radical and
x=1, 2 or 3; y=1, 2 or 3; x+y≦4 and z=4−x−y;
at least one metal compound selected from the group consisting of metal acetylacetonates, metal alkoxides and alkoxy-metal acetylacetonates, and,
at least one amine.

2. The primer according to claim 1, in which the copolymer is a pressure-sensitive adhesive.

3. The primer according to claim 1, wherein the sum of the weight contents of vinylcaprolactam and vinylpyrrolidone in the monomer mixture is 10 to 50 wt. %, based on the total weight of the monomer mixture.

4. The primer according to claim 1, wherein the monomer mixture comprises a maximum of 1.0 wt. % of acrylic acid, based on the total weight of the monomer mixture.

5. The primer according to claim 1, wherein the monomer mixture comprises n-butyl acrylate.

6. The primer according to claim 1, wherein the content of the copolymer, based on the total weight of the primer, is 1 to 30 wt. %.

7. The primer according to claim 1, wherein the at least one organofunctional silane is one or more of: N-cyclohexylaminomethyltriethoxysilane (CAS no.: 26495-91-0), methacryloxymethylmethyldimethoxysilane (CAS no.: 121177-93-3), methacryloxymethyltrimethoxysilane (CAS no.: 54586-78-6), N-trimethoxysilylmethyl-O-methyl carbamate (CAS no. 23432-64-6) and N-dimethoxy(methyl)silylmethyl-O-methyl carbamate (CAS no.: 23432-65-7).

8. The primer according to claim 1, wherein the metal of the metal compound is selected from the group consisting of: titanium, aluminium, zirconium, zinc and iron.

9. The primer according to claim 1, wherein the at least one amine contains no Si—O-alkyl group.

10. The primer according to claim 1, wherein the at least one amine is a primary amine.

11. The primer according to claim 1, wherein the weight content of the total of all the metal compounds in the mixture G is greater than the weight content of the total of all of the amines.

12. The primer according to claim 1, wherein the one or more solvents have boiling points of less than or equal to 100° C. under normal pressure.

13. A method of producing an adhesion-promoting layer, the method comprising the steps of:
applying a primer according to claim 1 onto a substrate, and subsequently removing the one or more solvents.

14. The method according to claim 13, wherein the adhesion-promoting layer is a pigmented adhesion-promoting layer.

15. A substrate having applied thereto a mixture G of the primer composition according to claim 1.
